(19) United States
(12) Patent Application Publication
(10) Pub. No.: US 2010/0092093 A1
(43) Pub. Date: Apr. 15, 2010

(54) FEATURE MATCHING METHOD

(75) Inventors: Yuichiro AKATSUKA, Tama-shi (JP); Takao SHIBASAKI, Tokyo (JP); Yukihito FURUHASHI, Hachioji-shi (JP); Kazuo ONO, Hachioji-shi (JP); Ulrich NEUMANN, Manhattan Beach, CA (US); Suya YOU, Arcadia, CA (US)

Correspondence Address: SCULLY SCOTT MURPHY & PRESSER, PC, 400 GARDEN CITY PLAZA, SUITE 300, GARDEN CITY, NY, 11530, US

(73) Assignee: OLYMPUS CORPORATION, Tokyo (JP)

(21) Appl. No.: 12/539,786

(22) Filed: Aug. 12, 2009

Related U.S. Application Data
(63) Continuation of application No. PCT/US2007/003653, filed on Feb. 13, 2007.

(51) Int. Cl. G06K 9/64; G06K 9/46

(52) U.S. Cl. 382/203; 382/218

(57) ABSTRACT

In a feature matching method for recognizing an object in two-dimensional or three-dimensional image data, features in each of which a predetermined attribute in the two-dimensional or three-dimensional image data takes a local maximum and/or minimum are detected, and features existing along edges and line contours from the detected features are excluded. Thereafter, the remaining features are allocated to a plane, some features are selected from the allocated features by using local information, and feature matching for the selected features being set as objects is performed.

### CROSS REFERENCE TO RELATED APPLICATIONS

This is a Continuation Application of PCT Application No. PCT/US2007/003653, filed Feb. 13, 2007, which was published under PCT Article 21(2) in English.

### BACKGROUND OF THE INVENTION

1. Field of the Invention

The present invention relates to a feature matching method for recognizing an object in two-dimensional or three-dimensional image data.

2. Description of the Related Art

U.S. Pat. No. 7,016,532 B2 discloses a technique of recognizing an object by carrying out a plurality of processing operations (such as generation of a bounding box, geometry normalization, wavelet decomposition, color cube decomposition, shape decomposition, and generation of a grayscale image with a low resolution) with respect to one target region.

### BRIEF SUMMARY OF THE INVENTION

According to one aspect of the present invention, there is provided a feature matching method for recognizing an object in two-dimensional or three-dimensional image data, the method comprising:

detecting features in each of which a predetermined attribute in the two-dimensional or three-dimensional image data takes a local maximum and/or minimum;

excluding features existing along edges and line contours from the detected features;

allocating the remaining features to a plane;

selecting some features from the allocated features by using local information; and

performing feature matching for the selected features.

Advantages of the invention will be set forth in the description which follows, and in part will be obvious from the description, or may be learned by practice of the invention. Advantages of the invention may be realized and obtained by means of the instrumentalities and combinations particularly pointed out hereinafter.

### BRIEF DESCRIPTION OF THE SEVERAL VIEWS OF THE DRAWING

The accompanying drawings, which are incorporated in and constitute a part of the specification, illustrate embodiments of the invention, and together with the general description given above and the detailed description of the embodiments given below, serve to explain the principles of the invention.

FIG. 1 is a block diagram depicting a feature matching method according to a first embodiment of the present invention.

FIG. 2A is a view showing an original image.

FIG. 2B is a view showing an array of multi-scale images that are used for detecting features.

FIG. 2C is a view showing features detected by a multi-scale feature detection.

FIG. 3A is a view showing matching between features of an original image and features of an image obtained by moving the original image in parallel by 20 pixels.

FIG. 3B is a view showing matching between features of an original image and features of an image obtained by multiplying the original image by 0.7.

FIG. 3C is a view showing matching between features of an original image and features of an image obtained by rotating the original image by 30 degrees.

FIG. 3D is a view showing matching between features of an original image and features of an image obtained by carrying out sharing of 0.4 so that the original image is equivalent to an affine-3D transformation.

FIG. 4 is a view showing a final matching result from a dataset.

FIG. 5 is a block diagram depicting a high speed matching search technique in a feature matching method according to a second embodiment of the present invention.

FIG. 6 is a view for explaining a Brute-Force matching technique.

FIG. 7 is a view showing an example of a matching search of two multi-dimensional sets using an exhaustive search.

FIG. 8 is a view showing an experimental statistic result of a time required for a matching search using an exhaustive search with respect to a large amount of feature points.

FIG. 9A is a view showing procedures for hierarchically decomposing a whole feature space into some subspaces.

FIG. 9B is a view showing the hierarchically decomposed subspaces.

FIG. 10 is a view showing a statistic result of a comparative experiment between a Brute-Force matching technique and high speed matching technique with respect to a small database.

FIG. 11 is a view showing a statistic result of a comparative experiment between a Brute-Force matching technique and high speed matching technique with respect to a large database.

FIG. 12 is a view showing the configuration of an information retrieval system of a first application.

FIG. 13 is a flowchart showing operation of the information retrieval system of the first application.

FIG. 14 is a view showing the configuration of a modified example of the information retrieval system of the first application.

FIG. 15 is a view showing the configuration of an information retrieval system of a second application.

FIG. 16 is a view showing the configuration of a modified example of the information retrieval system of the second application.

FIG. 17 is a view showing the configuration of another modified example of the information retrieval system of the second application.

FIG. 18 is a flowchart showing operation of a mobile phone employing the configuration of FIG. 17.

FIG. 19 is a view showing the configuration of an information retrieval system of a third application.

FIG. 20 is a view showing the configuration of a product recognition system of a fourth embodiment.

FIG. 21 is a view of features preliminarily registered in a database (DB).

FIG. 22 is a flowchart of product settlement by the product recognition system of the fourth application.

FIG. 23 is a flowchart of an extraction and recognition process of features.

FIG. 24 is a view used to explain an object of comparison between features in an image from a camera and features in a reference image registered in advance.

FIG. 25 is a view of an overall configuration of a retrieval system of a fifth application.

FIG. 26 is a block diagram of the configuration of the retrieval system of the fifth application.

FIG. 27 is a flowchart showing operation of the retrieval system of the fifth application.

FIG. 28 is a detailed flowchart of a process for matching with the DB.

FIG. 29 is a view of a display screen of a display unit of a digital camera in the event of displaying only one image candidate.

FIG. 30 is a view of a display screen in the event of displaying nine image candidates.

FIG. 31 is a flowchart used to explain an example of a feature DB creation method.

FIG. 32 is a flowchart used to explain another example of the feature DB creation method.

FIG. 33 is a flowchart used to explain another example of the feature DB creation method.

FIG. 34 is a flowchart used to explain yet another example of the feature DB creation method.

FIG. 35 is a view used to explain an operation concept in the case that a station name board of a station is photographed as a signboard.

FIG. 36 is a view of an example displaying a photograph on a map.

FIG. 37 is a view of another example displaying a photograph on a map.

FIG. 38 is a view of an example of a photograph display on a map in the case of a large number of photographs.

FIG. 39 is a view of another example of a photograph display on a map in the case of a large number of photographs.

FIG. 40 is a block diagram of the configuration of a retrieval system of a sixth application.

FIG. 41 is a flowchart showing operation of the retrieval system of the sixth application.

FIG. 42 is a detailed flowchart of an image acquisition process for imaging a printout.

FIG. 43 is a flowchart used to explain a feature DB creation method.

FIG. 44 is a block diagram of the configuration of a camera mobile phone employing a retrieval system of a seventh application.

FIG. 45 is a flowchart showing operation of a retrieval system of an eighth application.

FIG. 46 is a view used to explain general features used in a retrieval system of a ninth application.

FIG. 47 is a view used to explain detail features used in the retrieval system of the ninth application.

FIG. 48 is a view used to explain a positional relationship between original image data, the general features, and the detail features.

FIG. 49 is a flowchart showing operation of the retrieval system of the ninth application.

FIG. 50 is a view used to explain detail features with attention drawn to a central portion of image data.

FIG. 51 is a view used to explain detail features distributively disposed within an image.

FIG. 52 is a view used to explain detail features in which an attention region is placed in focus position in the event of imaging an original image.

FIG. 53 is a view used to explain detail features created in a region identical to that of general features.

FIG. 54 is a flowchart showing operation of a retrieval system of a tenth application.

FIG. 55 is a view showing the configuration of a retrieval system of an eleventh application.

FIG. 56 is a flowchart showing a recognition element identification process.

### DETAILED DESCRIPTION OF THE INVENTION

Hereinafter, a feature matching method according to the present invention will be described with reference to the accompanying drawings.

### First Embodiment

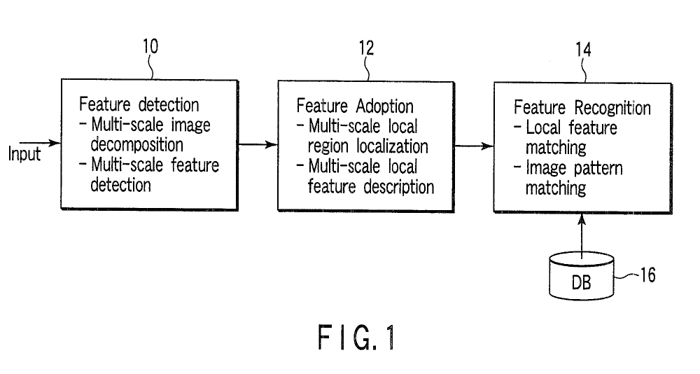

A feature matching method according to a first embodiment of the present invention is also referred to as a PBR (Point Based Recognition). As shown in FIG. 1, this method includes three portions: feature detection 10; feature adoption 12; and feature recognition 14. The features are spatially and temporally dispersed. For example, in the case where an image is to be recognized by this method, feature matching in a two-dimensional expanse is carried out. Recognition of a moving picture can be carried out in consideration of time-based expanse.

The feature detection 10 detects spatially stable features, which do not depend on a scale or a layout, from inputted object data, for example, an image. The feature adoption 12 adopts a robust and stable portion for making robust recognition from the features detected by the feature detection 10. The feature recognition 14 uses the features extracted by the feature adoption 12 and additional constrains to locate, index, and recognize objects pre-analyzed and stored in a database 16.

Now, a detailed description will be given with respect to each one of these feature detection 10, feature adoption 12, and feature recognition 14.

First, a description will be given with respect to the feature detection 10.

Robust recognition depends on both of the proprieties of selected features and methods used to match them. Good features should make the matcher work well and robust. Therefore, the integrated design of appropriate feature types and matching methods should exhibit reliability and stability. In general, large-scale features such as lines, bobs, or regions, are easier to match, because they provide more global information for the temporal matching computation. However, the large-scale features are also prone to significant imaging distortions that arise from variations of view, geometry, and illumination. Therefore, matching them requires storing conditions and assumptions to compensate for these distortions. Unfortunately, the geometry needed to model these conditions is usually unknown, so large-scale features often only recover approximate image geometry.

For image recognition, there is a need to recover accurate 2D correspondences in an image space, and matching small-scale features such as points has an advantage that the corresponding measurements are possible to at least the accuracy of the pixel resolution. Furthermore, a point feature has advantages over the large-scale features (such as lines and faces) in distinctiveness, robustness to occlusions (when part of the features is hidden), and good invariance to affine transformation. The related disadvantages of point features are that often only a sparse set of points and measurements are available, and matching them is also difficult, because only local information is available. However, if many point features are detected reliably, then a potentially large number of image corresponding measurements should be re-coverable, without the degradation of measurement quality introduced by the various assumptions and constraints required by other type features. Actually, observations with many methods using large-scale features or recovering full affine field that the most reliable measurement often occur near feature points. Considering these factors, points (feature points) are opted to employ as recognizing features.

General feature detection is a non-trivial problem. For image matching or recognition, the detected features should demonstrate good reliability and stability with the recognizing method, even when they do not have any physical correspondence to structure in the real world. In another words, feature detection methods should be able to detect as many as possible the features that are reliable, distinctive, and repeatable under various affine imaging conditions. This guarantees that it is possible to allocate enough features for further image matching and parameter recovering if the most of the features are occluded.

The feature detection 10 in the present embodiment uses a method for finding the point features with rich-texture regions. In this method, three filters are used. First, a high-frequency passed filter is used to detect the points having local maximum responds. Let R is a 3×3 windows centered are point P, and F(P) is the output of applying a high-frequency filter F to this point. If

F(P)=max {P>Pi:R}>Threshold (1)

then point P is a feature candidate, and saved for further examining. This filter may be used to extract local minimum responds.

The second filter is a distinctive feature filter. As is known, the points lie along the edges or linear contours are not stable for matching. This is so-called matching arbitrary effect (effect that can be seen as if matching were successful), and these points must be removed for reliable matching. In addition, it is known that the covariance matrix of image derivatives is a good indicator to measure the distributions of image structure over a small patch. Summarizing the relationship between the matrix and image structure, small eigenvalues of correspond to a relatively constant intensity within a region. A pair of large and small eigenvalues corresponds to a high texture pattern, and two large eigenvalues can represent linear features, salt-and-pepper textures, or other patterns. Therefore, it is possible to design the filter to remove those linear feature points.

Let M is a 2×2 matrix computed from image derivatives,

$$M = {\sum }_{x ∈ Ω} {W}^{2} ( x ) [ \begin{matrix}{{I}_{x} ( x , t )}^{2} & {I}_{x} ( x , t ) {I}_{y} ( x , t ) \\ {I}_{y} ( x , t ) {I}_{x} ( x , t ) & {{I}_{y} ( x , t )}^{2}\end{matrix} ] \qquad ( 2 )$$

and λ₁ and λ₂ are eigenvalues of M. The measure of a linear edge response is

R=det(M)−k(trace(M))² (3)

where the det(M)=λ₁λ₂, and trace(M)=λ₁+λ₂.

So, if the edge response

R(P)>Threshold (4)

then point P is treated as a linear edge point and removed from feature candidate list.

The third filter is an interpolation filter which iteratively refines the detected points to sub-pixel accuracy. An affine plane is first used to fit the local points to reconstruct a continuous super-plane. Then the filter iteratively refines the points upon the reconstructed plane till an optimal fitting solution is converge and the final fitting is used to update the points to the sub-pixel accuracy.

A novel aspect of the present embodiment is that scale invariance is improved by employing a multi-resolution technique, thereby extracting features from each of a plurality of images having various resolutions.

To achieve affine scale invariance, a multi-resolution strategy is employed in the above feature detection processing. Unlike the traditional pyramid usage in which the main goal is to accelerate the processing, i.e. coarse-to-fine search, it is a goal to detect all the possible features across different scales to achieve a effective affine scale invariance. So, the features in each level of the pyramid are processed dependently.

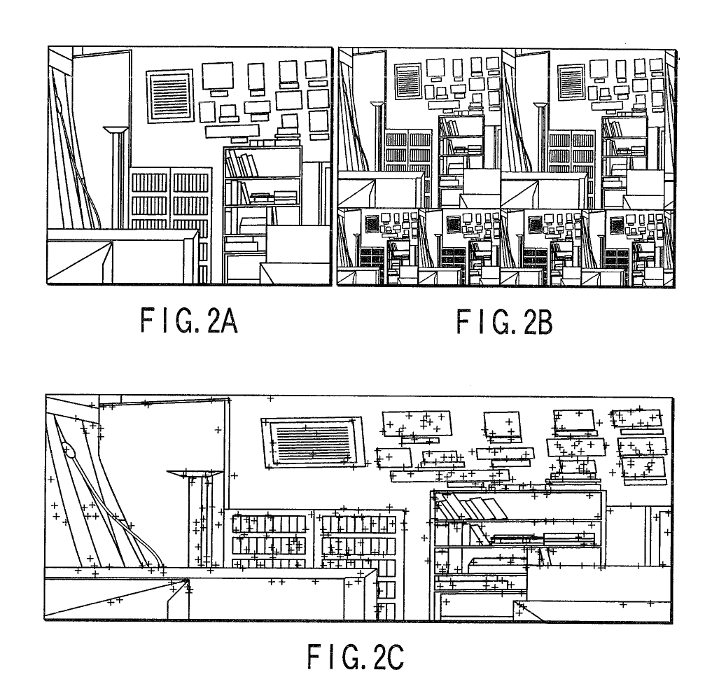

FIGS. 2A to 2C each show a result for this approach has been applied to a cluttered scene. FIG. 2A shows an original image, FIG. 2B shows an array of multi-scale images that are used for detecting features, and FIG. 2C shows the detected features, respectively.

Now, a description will be given with respect to the feature adoption 12.

Once features have been detected in the above feature detection 10, the thus detected features have to be adopted as in a robust and stable representation for robust recognition. As described above, the related disadvantages of using point features as matching primitives are that often only a sparse set of points and only local information is available, which make the matching is difficult. An appropriate strategy of feature adoption is very important to deal with the variations of viewpoint, geometry, and illumination.

In the approach, the feature adoption 12 in the present embodiment adopts each feature point using its local region information, called affine region. Three constraints are used to quality the local region, i.e., intensity, scale, and orientation. The intensity constraint is the image gradient value G(x, y) calculated inside the region pixels, which indicate the texture-ness of the feature.

G(x,y)=\sqrt{∇x²+∇y²} (5)

In the situation of small base line of two matched images, the intensity adoption is sufficient to match the images under small linear displacements. A simply correlation matching strategy could be used. Furthermore, if the matched images have larger imaging distortion, an affine warping matching is effect to compensate for the distortion.

However, under the situation of large image base line, in which the matched images have serious geometric deformation including scaling, 2D and 3D rotations, the simple intensity adoption is not sufficient. It is well known that the simple intensity correlation is not scale and rotation invariant. In this situation, the all the possible constraints should be considered in order to adopt the matching points as in a robust and stable multi-quality representation. The scale and local orientation constraints are embedded into the adoption and matching processing. First, the continuous orientation space is quantized into discrete apace.

{O_{discrete}(xₙ,yₙ):n=1, 2, . . . N)=Quant{O_{continue}(x,y):x,yε[0,2π]) (6)

O_{continue}(x, y)=arctan(∇y/∇x) (7)

These quantized orientations form the bases spanning the orientation space. By applying the image decomposition model, all local orientation of feature can be assigned to the discrete base space. In this way, the features in term of their local orientations can be built by a compact representation. To form a consistent representation for all the considered qualities (intensity, scale, and orientation), the intensity and scale values are used to vote the contributions of every local orientation to the matching feature. Furthermore, to reduce the quantization effect (error), a Gaussian smooth function (Gaussian smooth processing) is also used to weighting the voting contributions.

A novel aspect of the present embodiment is that features of the orientations normalized from the peripheral regions of the features are provided in the form as shown in formula (8) below.

Let R is a voting range that its size is defined by a Gaussian filter used for generating a scale pyramid. For any point P(xᵢ, yᵢ) within the voting range, its contribution to a quantized orientation is represented by formula (8) below:

$$\{ {O}_{discrete} ( {x}_{n} , {y}_{n} ) \text{:} n = 1 , 2 , … N ) = {\sum }_{i ∈ R} G ( {x}_{i} , {y}_{i} ) * Weight ( {x}_{i} , {y}_{i} ) \qquad ( 8 )$$

where, G(xᵢ, yᵢ) is a gradient computed with formula (5) above, and Weight(xᵢ, yᵢ) is a Gaussian weighting function centered at the processed point (x, y), as shown in formula (9) below:

Weight(xᵢ,yᵢ)=exp(−((xᵢ−x)²+(yᵢ−y)²)/σ²) (9)

The above adoption strategy is effect to handle image scaling and out-of-plane rotation, but, it is still sensitive to in plane orientation. To compensate this variance, an affine region is normalized to a coincided direction during the voting computation. Again, to cancel the quantization effect of the coincided rotation, a bi-linear interpolation and Gaussian smoothing processing are applied within a window coincide. Also, to increase the robustness with respect to variance of lighting condition, the input image is normalized.

The final output of the feature adoption 12 is a compact vector representation for each matching point and associated region that embeds all the constraints, achieving affine geometry and illumination invariance.

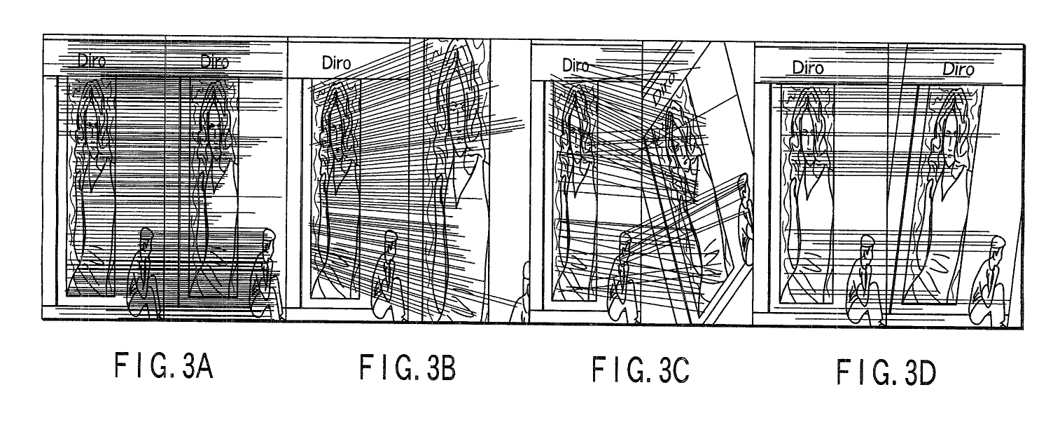

FIGS. 3A to 3D each show a result of using this approach to a scene under different affine transformation. FIG. 3A is a scene obtained by moving the original image in parallel by 20 pixels; FIG. 3B is a scene obtained by multiplying the original image by 0.7; FIG. 3C is a scene obtained by rotating the original image by 30 degrees; and FIG. 3D is a scene obtained by carrying out sharing of 0.4 so that the original image is equivalent to an affine-3D deformation, respectively.

Now, a description will be given with respect to the feature recognition 14.

The features detected by the feature detection 10 and adopted by the feature adoption 12 establish good characteristics for geometry invariance. The matching is performed based on the adopted feature representations. The SSD (Sum of Square Difference) is used for the similarity matching, i.e. for each features P, a similarity value Similarity(P) is computed against the matched image, and the SSD search is performed to find the best matched point with maximal similarity. If the following relationship is established,

Similarity (P)={P, Pᵢ}>Threshold (10)

it indicates that Pᵢ is the matched point of P.

It is effective to utilize a pair of evaluation techniques utilizing RANSAC (Random Sample Consensus) as a reliability evaluation technique for image recognition, and in particular, to calculate a posture at the time of image recognition from an affine transformation matrix calculated in accordance with this technique when a small number of matched points exist, making it possible to evaluate reliability of image recognition based on the calculated posture.

The experimental results show that the above multi-constraint feature representation establish good characteristics for image matching. For the very cluster scenes, however, mismatching (i.e. outliers) may happen, especially for the features that located in the background. To remove those matching outliers, a RANSAC based approach is used to make a search for a pair that fulfills the fundamental geometrical constraint. It is well known that the matched image features corresponding to a same object will fulfill a 2D parametric transformation (a homography). To accelerate the computation, the feature recognition 14 uses the 2D affine constraint to approximate the homography for outlier removing, which requires only 3 points to estimate the parametric transformation. First, the RANSAC iteration is applied using randomly selected 3 features to estimate an initial transformation Mᵢₙᵢₜ.

$${M}_{init} = [ \begin{matrix}{m}_{1} & {m}_{2} & 0 \\ {m}_{3} & {m}_{4} & 0 \\ {m}_{5} & {m}_{6} & 1\end{matrix} ] \qquad ( 11 )$$

The estimated parametric transform is then refined iteratively using all the matched features. The matching outliers (mismatching) are indicated for those matching points that have large fitting residuals.

$$\begin{matrix}Outlines ( {P}_{i} ) = residuals ( Pi ) > Threshold & ( 12 ) \\ residual ( {P}_{i} ) = {\sum }_{i ∈ all the point s} ( \sqrt{{( {x}_{i}^{t} - {x}_{i}^{s} )}^{2}} + \sqrt{{( {y}_{i}^{t} - {y}_{i}^{s} )}^{2}} ) & ( 13 )\end{matrix}$$

where xᵢt is the warped point of xᵢ toward to xᵢ^{s} by applying the estimated affine transformation, i.e.

$$[ \begin{matrix}{x}_{i}^{t} \\ {y}_{i}^{t}\end{matrix} ] = [ \begin{matrix}{m}_{1} {x}_{i} + {m}_{2} {y}_{i} + {m}_{3} \\ {m}_{4} {x}_{i} + {m}_{5} {y}_{i} + {m}_{6}\end{matrix} ] \qquad ( 14 )$$

The final output of the feature matching is a list of matching points with outlier indicators and the estimated 2D parametric transformation (affine parameters).

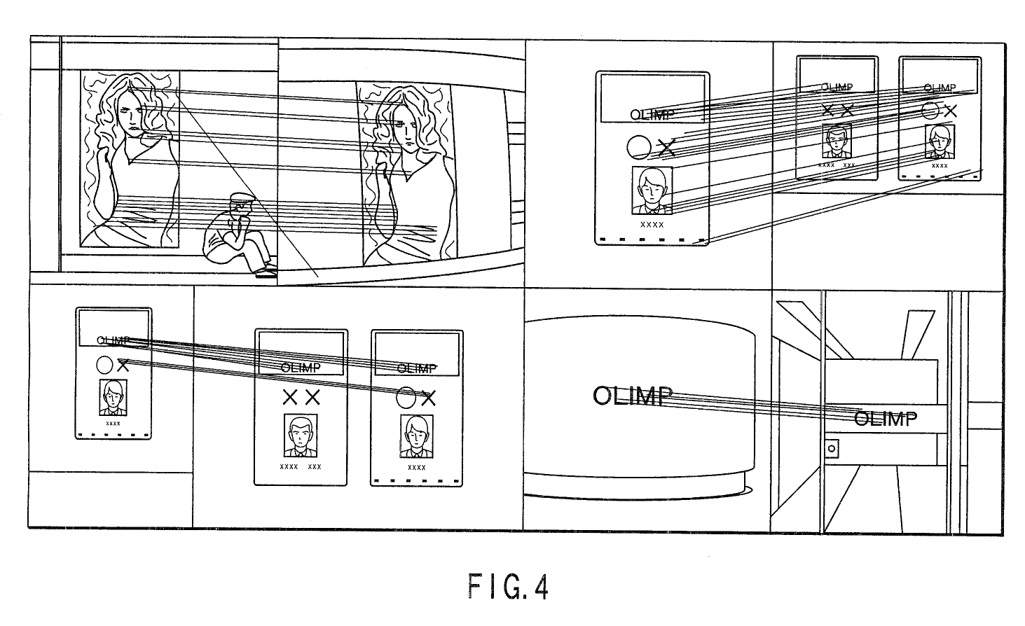

FIG. 4 shows an example of the final matching results obtained by this feature recognition 14 from an object dataset pre-analyzed and stored in the database 16.

### Second Embodiment

The present embodiment describes a fast matching search for achieving further speed in the foregoing feature recognition 14.

This fast matching search is referred to as a Data Base Tree (dBTree). The dBTree is an effective image matching search technology that can rapidly recover possible matches to a high-dimensional database 16 from which PBR feature points as described in the foregoing first embodiment have been extracted. Technically, the problem is a typical NP data query problem, i.e. given an N-dimension database points and a query point q, it is wanted that the closest matches (Nearest Neighbors) of q among the database is fined. The fast matching search according to the present embodiment is a tree-structure matching approach that forms a hierarchical representation of the PBR features to achieve an effective data representation, matching, and indexing of high-dimensional feature spaces.

Technically, the dBTree matcher, as shown in FIG. 5, is composed of dBTree construction 18, dBTree search 20, and match indexing 22. In order to achieve a rapid feature search and query, the dBTree construction 18 creates a hierarchical data representation over the PBR feature space (hereinafter, referred to as a dBTree representation) from the PBR features obtained from the object data input as described in the foregoing first embodiment. The created dBTree representation is registered in the database 16. The dBTree representation relevant to data on a number of objects is thus registered in the database 16. The dBTree search 20 searches over the dBTree space configured in the database 16 to locate possible Nearest Neighbors (NNs) of given PBR features obtained from the input object data as described in the first embodiment. The match indexing 22 uses the found NNs and additional PBR constrains to locate and index corrected matches.

Before describing in detail a dBTree approach in the present embodiment, a description will be given with respect to a problem to be solved in the match search.

The goal of the match search is to rapidly recover possible matches to a high-dimensional database. Although the present embodiment focuses on a specific case of PBR feature matching, this dBTree search structure is generic suitable for any data search applications.

Given two sets of points: P={pᵢ, i=1, 2, . . . , N} and Q={qⱼ, j=1, 2, . . . , M}, where pᵢ and qⱼ are k-dimensional vectors, for example, 128-D vector for PBR feature, the goal is to find all possible matches between the two point sets P and Q, i.e. Matches={pᵢ<=>qⱼ} under certain matching similarity.

Since the PBR features establish good invariant characteristics for feature matching, a Euclidean distance for the invariant features is used for the similarity matching, i.e. for each feature pᵢ, a similarity value Similarity(pᵢ) is computed against the matched features qⱼ, and the matching search is performed to find the best matched point with minimal Euclidean distance.

Obviously the matching performance and speed are heavily depended on the dimensions N and M of the two point sets.

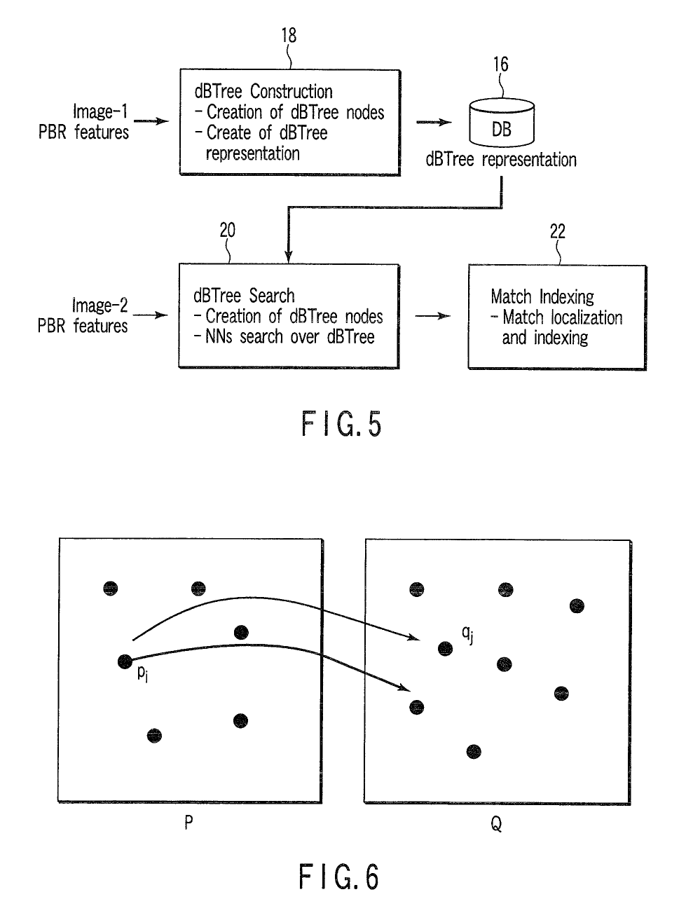

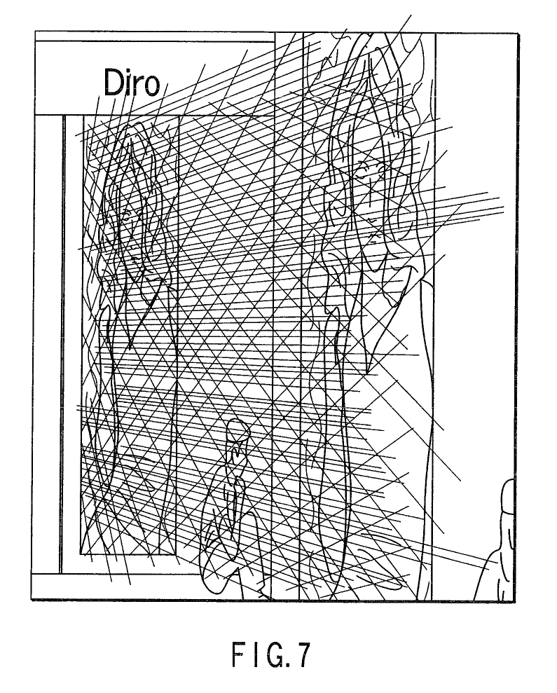

To match the points of two datasets, the first intuition would probably be a Brute-Force exhaustive search method. As shown in FIG. 6, a Brute-Force approach takes every point of set P and calculates its similarity against each point in the set Q. Obviously the matching speed of exhaustive search is linearly proportional to the dimensions of point sets, resulting in total O(N×M) algorithmic operations (Euclidean distance computation). For matching of two typical PBR feature sets with 547 points and 547 points, for example, the Brute-Force matching will take 3.79 seconds on a 1.7 GHz PC. FIG. 7 shows an example of matching two high-dimensional datasets (2955 points by 5729 points) using the exhaustive search will result in 169.89 seconds.

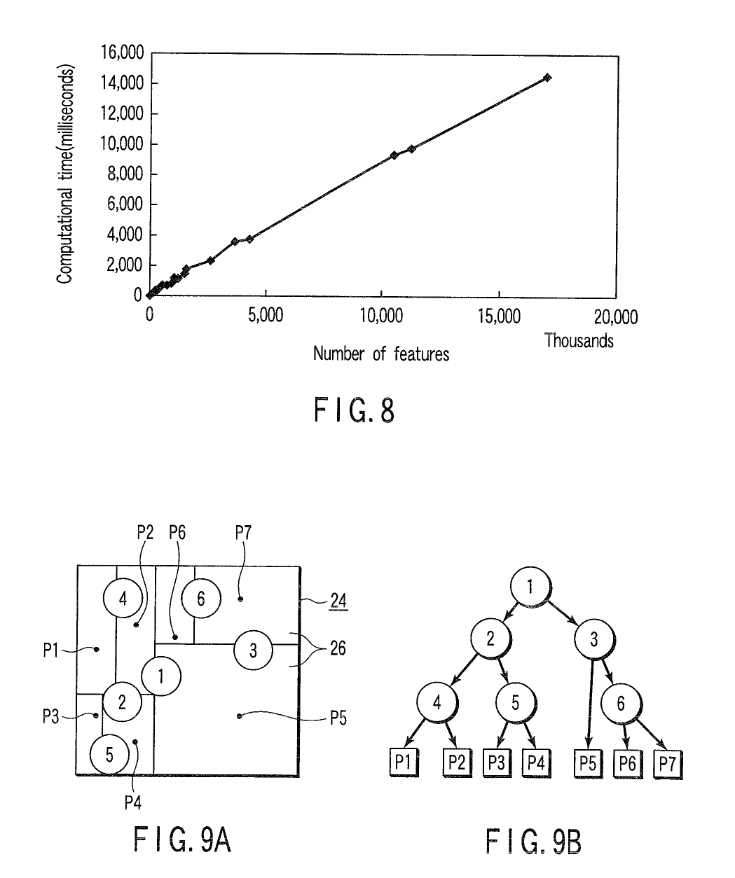

FIG. 8 shows experimental statistic results (over 50 testing images) of the matching time of Brute-Force search with respect to the number of feature points (the total feature numbers N×M of input image features N and database features M).

Now, a detailed description will be given with respect to a dBTree approach in the present embodiment.

First, a description will be given with respect to the dBTree construction 18.

A central data structure in the dBTree matcher is a tree structure that forms an effective hierarchical representation of the feature distribution. Unlike the scan-line feature representation (i.e. every feature is represented in a grid structure) used in a Brute-Force search, the dBTree matcher represents the k-dimension data in a balanced binary tree by hierarchically decomposing the whole space into several subspaces according to the splitting value of each tree-node. The root-node of this tree represents the entire matching space, and the branch-nodes represent rectangular sub-spaces that contain the features having different characters of their enclosed spaces. Since the subspace is relatively small comparing to the original space such that it contains small number of input features, the tree representation should provide a fast way to access any input feature by feature's position. By traversing down the hierarchy until find the sub-spaces containing the input feature, an identifying operation of the matching points can be carried out merely by scanning trough few nodes in the sub-spaces.

FIGS. 9A and 9B each show procedures of hierarchically decomposing the whole feature space 24 into several subspaces 26 to build a dBTree data structure. First, input point sets are partitioned (segmented) in accordance with a defined splitting measure. The median filtering is used for the embodiment so that an equal number of points fall into each side of the split subspaces 26. Each node in the tree is defined by a plane through one of the dimensions that partitions the set of points into left/right and up/down subspaces 26, each with half the points of the parent node. These children nodes are again partitioned into equal halves, using planes through a different dimension. The process is repeated until partitioning reaches log(N) levels, with each point in its own leaf.

Now, a description will be given with respect to the dBTree search 20.

There are two steps for search a query point over the tree: search for closest subspace 26 and search for closest node within the subspace 26. First, the tree is traversed to find the subspace 26 containing the query point. Since the number of subspace 26 is relatively small, it is possible to rapidly locate the closest subspace 26 with only log(N) comparisons, and the space would have a high probability that contains that the matched points. Once locate the subspace 26, a node-level traversing is performed through all the nodes in the subspace 26 to identify the possible matching points. The process is repeated until the closest node is found to the query point.

The above search strategy has been tested and it does show certain speed-improvement on matching small dimensional dataset. To be surprised, however, it demonstrated extremely ineffective for large-scale dataset, even slower than the Brute-Force search approach. Analysis the reasons come from the two aspects. First, the efficiency of the traditional tree searching is based on the fact that many tree branches could be pruned if the distance to the query point is too far, which greatly reduces the unnecessary searching time. This is typical true for the low dimensional dataset, but for higher dimensions there are too many branches adjacent to the central one, which have to be examined. A lot of calculations are still carried out trying to prune the branches and looking for the best searching paths, which becomes a tree-type exhaustive search. Second, node-level traversing within the subspace 26 is also exhaustive through every contained node, depended entirely on the number of contained nodes. For a high-dimensional dataset, each subspace 26 still contains too many nodes that need to be exhaustively traversed.

In the present embodiment, two strategies (methods) are employed to overcome those problems and to achieve effective matching for high-dimensional dataset. First, a tree-pruning-filter (branch cutting filter) is used to cut (reduce) the number of branches needs to be examined. After exploring a specific number of nearest branches (i.e. search-steps), the branch search is enforced stopped. The distance filtering could also be used for this purpose, but extensive experiments have shown that using the search-steps filtering has demonstrated better performance in terms of corrected matches and computation cost. Although search results obtained from the strategy give approximate solutions are observed, experiments shows that the mismatching rate only increased less 2%.

The second strategy (method) is to improve the node search by introducing a node-distance-filter. Based on the matching consistent constraint that for the most of real-world scenes the correct matching will be mostly clustered, so, instead to search exhaustively for every feature node, a distance threshold is used for limiting the node research range. The node search is performed as a circular pattern so that nodes that are closer to the target will be searched first. Once the search boundary is reached, the search is enforced stopped and nearest neighbors (NNs) are outputted.

Now, a description will be given with respect to the index matching 22.

Once the nearest neighbors are detected, the next step is to decide if the NNs are accepted as correct matches. Same as that using in the original PBR point matcher, a related matching cost threshold is used for selecting correct matching, i.e. if the similarly difference between the highest NN and second-highest NN (a distance up to the highest NN/a distance up to the second-highest NN) is less than a pre-defined threshold, the point is accepted as correct match.

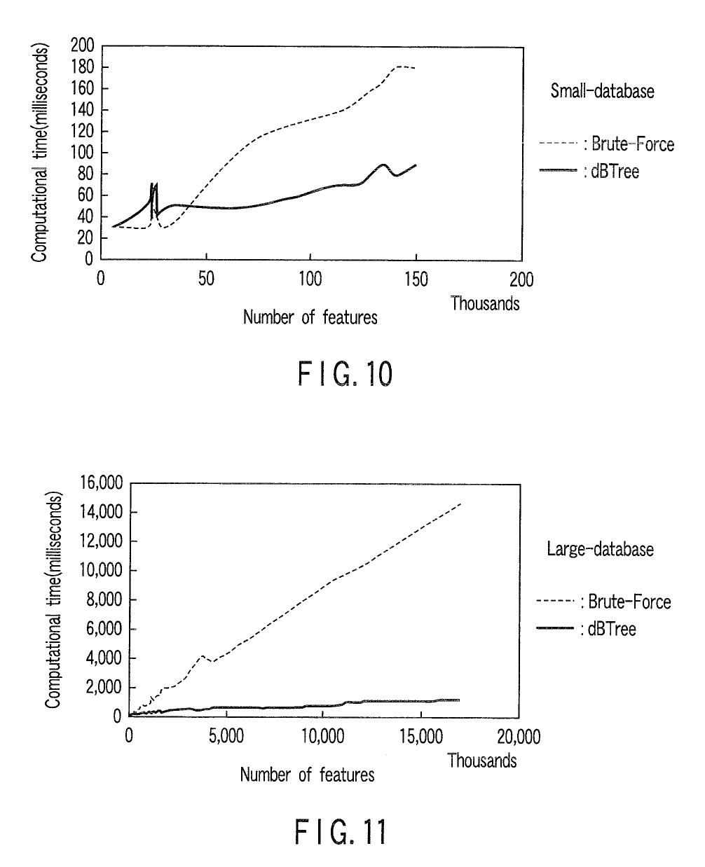

FIGS. 10 and 11 each show a statistical result (over 50 testing images) of comparative experiment between the Brute-Force and dBTree matching methods.

The difference in similarity between the highest NN and the second-highest NN is obtained as a parameter that expresses preciseness in identity judgment of the similarity of that point. In addition, the number per se of matching points in the image is also obtained as a parameter that expresses preciseness in identity judgment of the image. Further, a differential total sum (residual difference) in affine transformation of matching points in the image expressed by formula (13) above is also obtained as a parameter that expresses preciseness in identity judgment of the image. Part of these parameters may be utilized. Alternatively, a transform formula defining each of these parameters as a variable is defined, whereby this formula may be defined as preciseness of identity judgment in matching.

In addition, by utilizing a value of the preciseness, it becomes possible to output a plurality of images as a matched result in a predetermined sequence. For example, the number of matching points is utilized as preciseness, and then, the matching results are displayed in descending order of the number of matching points, whereby images are outputted in sequential order from the most reliable image.

Applications utilizing the feature matching method described above will be described herebelow.

[First Application]

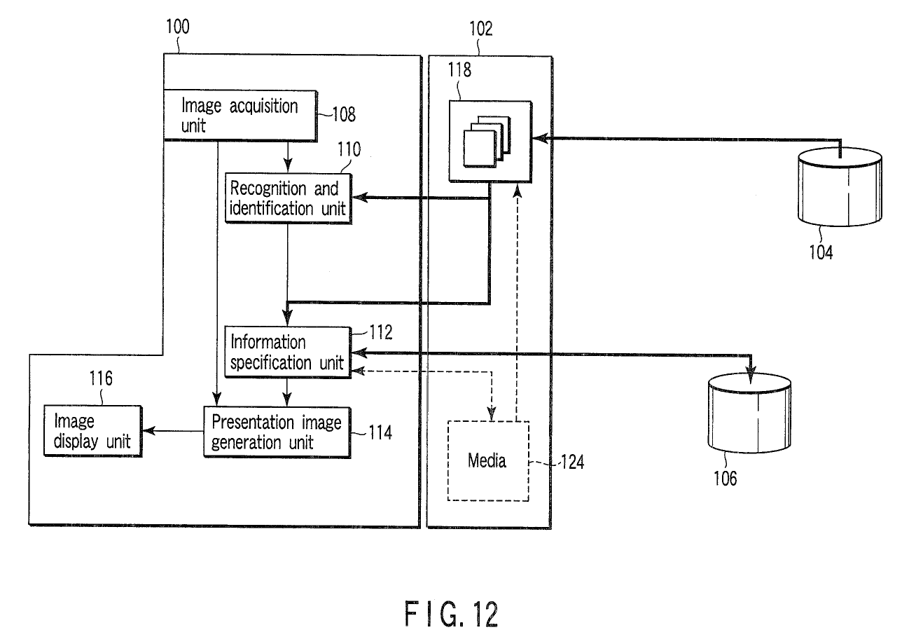

FIG. 12 is a view showing the configuration of an information retrieval system of a first application.

The information retrieval system is configured to include an information presentation apparatus 100, a storage unit 102, a dataset server 104, and an information server 106. The information presentation apparatus 100 is configured by platform hardware. The storage unit 102 is provided in the platform hardware. The dataset server 104 and the information server 106 are configured in sites accessible by the platform hardware.

The information presentation apparatus 100 is configured to include an image acquisition unit 108, a recognition and identification unit 110, an information specification unit 112, a presentation image generation unit 114, and an image display unit 116. The recognition and identification unit 110, the information specification unit 112, and the presentation image generation unit 114 are realized by application software of the information presentation unit installed in the platform hardware.

Depending on the case, the image acquisition unit 108 and the image display unit 116 are provided as physical configurations in the platform hardware, or are connected to outside. Thus, the recognition and identification unit 110, the information specification unit 112, and the presentation image generation unit 114 could be referred to as an information presentation apparatus. However, in the present application, the information presentation apparatus is defined to perform processes from the process of imaging or image capture to the process of final image presentation, such that the combination of the image acquisition unit 108, the recognition and identification unit 110, the information specification unit 112, the presentation image generation unit 114, and the image display unit 116 is herein referred to as the information presentation apparatus.

The image acquisition unit 108 is a camera or the like having a predetermined image acquisition range. The recognition and identification unit 110 recognizes and identifies respective objects within the image acquisition range from an image acquired by the image acquisition unit 108. The information specification unit 112 obtains predetermined information (display contents) from the information server 106 in accordance with information of the respective objects identified by the recognition and identification unit 110. The information specification unit 112 then specifies the predetermined information as relevant information. The presentation image generation unit 114 generates a presentation image formed by correlation between the relevant information, which has been specified by the information specification unit 112, and the image acquired by the image acquisition unit 108. The image display unit 116 is, for example, a liquid crystal display that displays the presentation image generated by the presentation image generation unit 114.

The storage unit 102 located in the platform contains a dataset 118 stored by the dataset server 104 via a communication unit or storage medium (not shown). Admission (downloading or media replacement) and storing of the dataset 118 is possible regardless of pre-activation or post-activation of the information presentation apparatus 100.

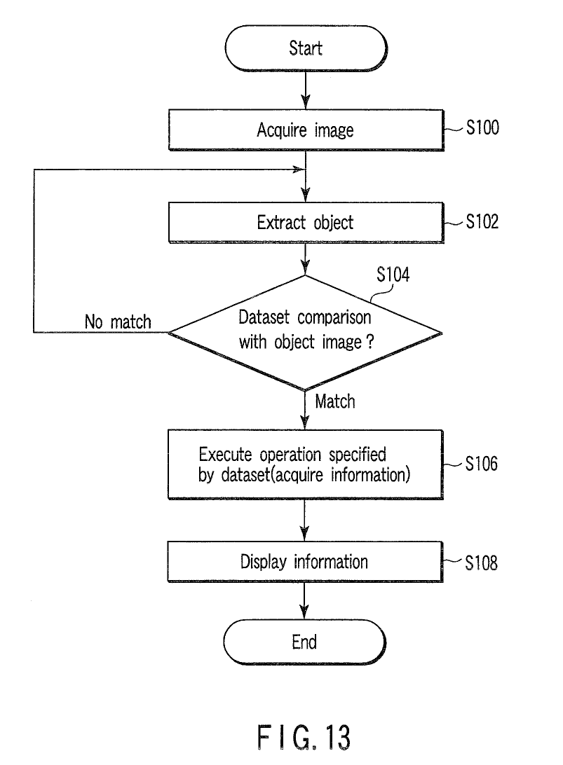

The information presentation apparatus 100 configured as described above performs operation as follows. First, as shown in FIG. 13, an image is acquired by the image acquisition unit 108 (step S100). Then, for the image acquired in step 5100 described above, the recognition and identification unit 110 extracts a predetermined object (step S102). Subsequently, the recognition and identification unit 110 executes comparison and identification of an image (image in a rectangular frame, for example) of the object, which has been extracted in step S102 described above, in accordance with features in the dataset 118 read from the storage unit 102 in the platform. In this manner, the recognition and identification unit 110 detects a matched object image. If the recognition and identification unit 110 has detected the matched object image (step S104), then a location and/or acquiring method for information necessary to be obtained from corresponding data in the dataset 118 is again read and executed in the information specification unit 112 (step S106). In an ordinary case, the information is obtained by accessing the information server 106, which externally exists in a network or the like, from the platform through communication. Then, the presentation image generation unit 114 processes the information (not shown) obtained in the information specification unit 112 so that the information can be displayed on the image display unit 116 provided in the platform or outside, thereby generating a presentation image. The presentation image thus generated is transferred to the image display unit 116 from the presentation image generation unit 114, whereby the information is displayed on the image display unit 116 (step S108). In this case, depending on the case, it is also a useful method for information presentation to be performed in the manner that information obtained as described above is superposed on the original image obtained in the image acquisition unit 108 to thereby generate and transfer presentation image to the image display unit 116. Therefore, the process is configured so that a user is permitted to select a method for the information presentation.

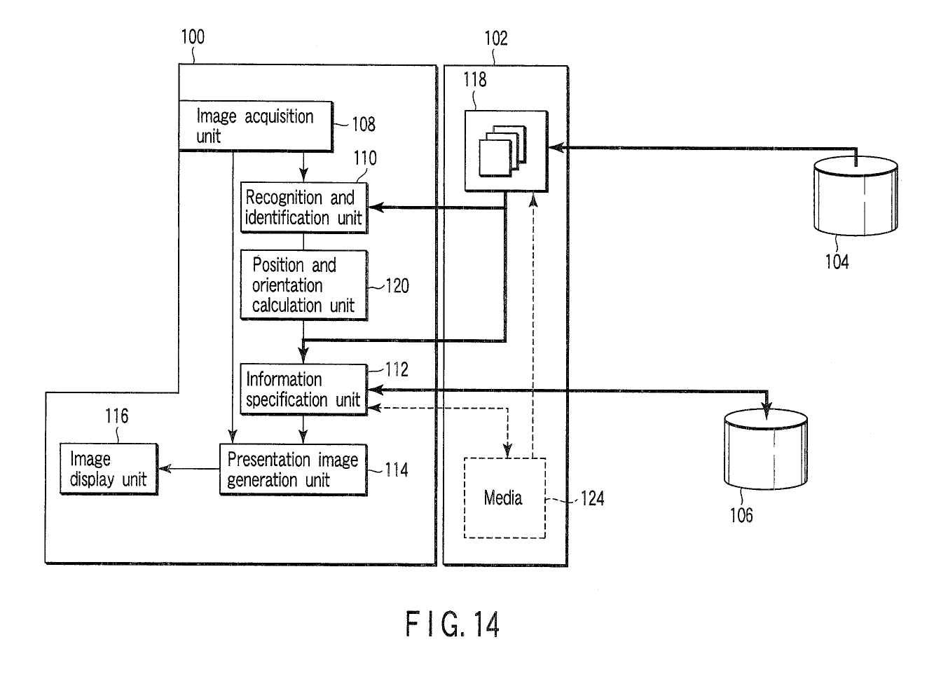

As shown in FIG. 14, the configuration can be such that a position and orientation calculation unit 120 is provided between the recognition and identification unit 110 and the information specification unit 112. The presentation image generation unit 114 generates a presentation image in such a form that relevant information specified by the information specification unit 112 is superposed on an image acquired by the image acquisition unit 108 in a position and orientation calculated by the position and orientation calculation unit 120.

Although not shown in FIGS. 12 and 14, in the case of a large storage capacity of the platform, things described hereinbelow can be implemented. In the event that the dataset 118 is admitted from the dataset server 104, the information server 106 and the dataset server 104 are controlled to communicate with one another. Thereby, information (display contents) corresponding to the dataset server 104, which allows admission of the information, is preliminarily admitted, that is, stored into the storage unit 102 in the platform. Thereby, operational efficiency of the information presentation apparatus 100 can be increased.

The first application using a camera mobile phone as a platform will be described herebelow. Basically, mobile phones are devices that are used by individuals. In recent years, most models of mobile phones allow admission (that is, installation by downloading) of application software from an Internet site accessible from the mobile phones (which hereinbelow will be simply referred to as a “mobile-phone accessible site”). The information presentation apparatus 100 is, basically, also assumed as a prerequisite to be a mobile phone of the aforementioned type. Application software of the information presentation apparatus 100 is installed into the storage unit 102 of the mobile phone. The dataset 118 is appropriately stored into the storage unit 102 of the mobile phone through communication from the dataset server 104 connected to a specific mobile-phone accessible site (not shown).

By way of example, a utilization range of the information presentation apparatus 100 in the mobile phones includes a utilization method described hereinbelow. For example, a case is assumed in which photographs existing in publications, such as magazines or newspapers, are preliminarily specified, and data sets relevant thereto are preliminarily prepared. In this case, a mobile phone of a user acquires an image of an object from paper space of any of the publications and then to read information relevant to the object from a mobile-phone accessible site. In such a case, it is impossible to retain all photographs, icons, illustrations, and like items contained in all publications as feature. Thus, it is practical to restrict the range to, for example, a specific use range, thereby to provide features. For instance, the data can be provided to a user in a summarized form, such as “a data set for referencing, as objects, photographs contained in an n-th month issue” of a specific magazine. With such an arrangement, usability for users is improved, and reference images, if 100 to several hundred pieces in one dataset, can be sufficiently stored into the storage unit 102 of the mobile phone, and in addition, the recognition and identification processing time can be within several seconds. Further, neither special contrivance nor process is necessary for, for example, photographs and illustrations on the side of prints that are used in the information presentation apparatus 100.

According to the first application described above, for the user, multiple items of data in a use range can be admitted by batch into the information presentation apparatus 100, the dataset supply side can easily be prepared therefore, and services easy to be commercially provided can be realized.

In the configuration further including the function of calculating the position and orientation, information obtained from the information server 106 becomes displayable with an appropriate position and orientation over an original image. Consequently, the configuration leads to enhancement of user information obtainment effects.

[Second Application]

A second application will be described herebelow.

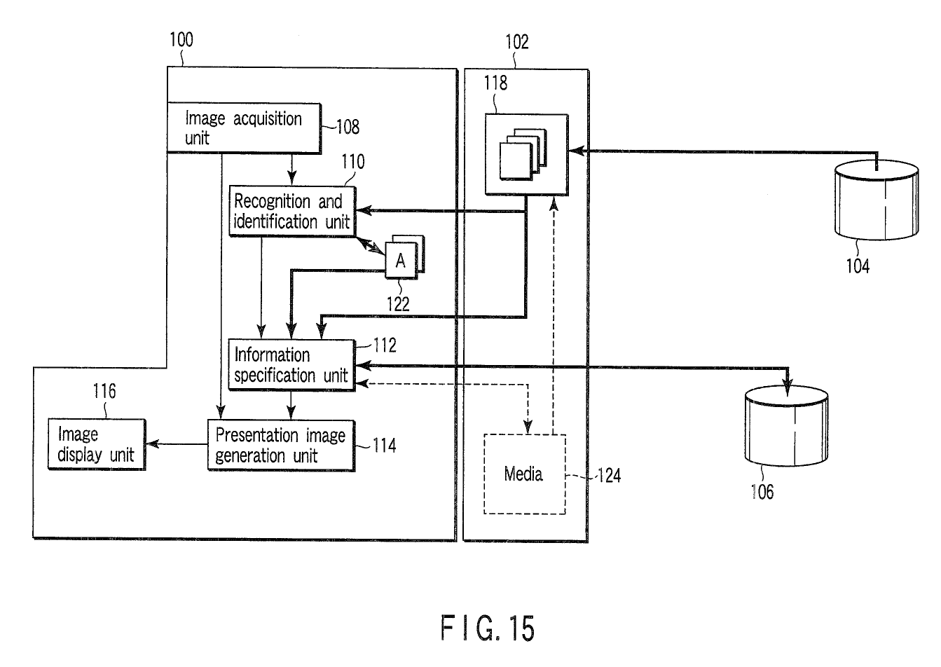

FIG. 15 is a view showing the configuration of an information retrieval system of the second application. The basic configuration and operation of the information retrieval system is similar to those in the first application. In an information presentation apparatus 100, features can be handled in units of the set, whereby, as described above, the usability for the user is increased, and data set supply is made practical.

However, in the case that the information presentation apparatus 100 becomes pervasive and data sets also are supplied in wide variety from many businesses, the following arrangements are preferably made. Of data, data enjoying high utilization frequency (which data hereinbelow will be referred to as “basic data” 122) is not supplied as a separate dataset 118, but preferably is provided usable even if any type of a dataset 118 is selected. For instance, it is useful that objects associated with index information of the dataset 118 itself or object and the like most frequently used is excluded from the dataset 118, but only the some number of features are stored to be resident in application software in the information presentation apparatus 100. More specifically, in the second application, the dataset 118 is composed in a set corresponding to the utilization purpose of a user or a publication or object correlated thereto, and is supplied as a separate resource from the application software. However, features or the like relevant to an object with an especially high utilization frequency or necessity is stored to reside or is retained as the basic data 122 in the application software itself.

Description will again be made with reference to the case in which a camera mobile phone is the platform. For example, it is most practical to download an ordinary dataset 118 through communication from a mobile-phone accessible site. In this case, however, it is convenient for a user of the mobile phone if guiding and retrieval can be performed in an index site (a page in the mobile-phone accessible site) of the dataset 118. Even in the event of access to the site itself, control is performed such that the information presentation apparatus 100 acquires an image of an object dedicated therefore, and a URL for the site is passed to accessing software to be accessible, so that special preparation of the dataset 118 is not necessary. As such, features corresponding to the object are stored to reside as the basic data 122 in the application software. In this case, a specific illustration or logo can be set as the object, or a plain rectangle freely available can be set as the object.

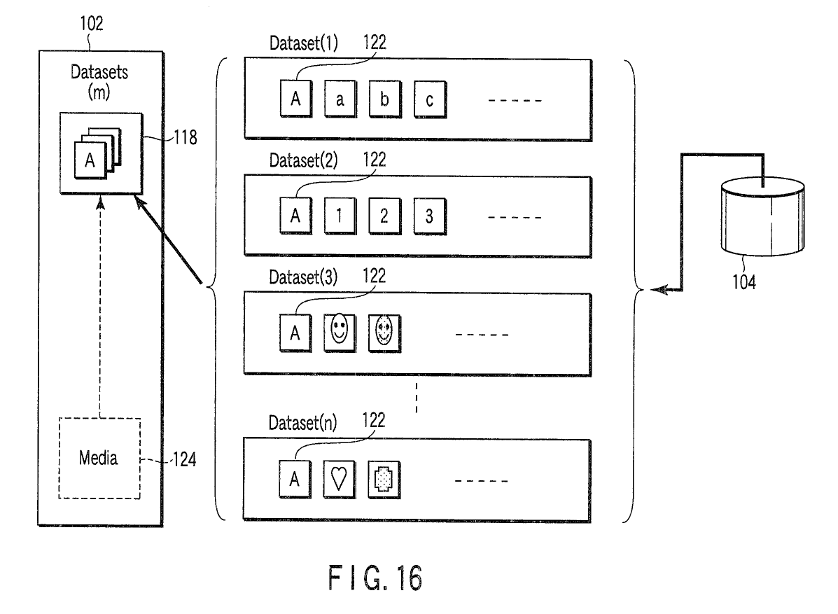

Alternatively, in lieu of the arrangement in which the basic data 122 is stored to reside or is retained in the application software itself, the configuration can be such that, as shown in FIG. 16, any of the datasets 118 to be supplied includes at least one set of an identical data file (“feature A” in the drawing) that always becomes the basic data 122.

More specifically, as described above, when actually operating the information presentation apparatus 100, the user admits an arbitrary dataset 118. At least one item of the basic data 122 is included in any of the datasets 118, so that it is always addressable for an object either with high utilization frequency or high necessity. For example, a case is contemplated in which, as shown in FIG. 16, a large number of datasets 118 (data sets (1) to (n)) are prepared; and among them, one or multiple sets of datasets 118 are admitted and stored into the storage unit 102 in the platform. In this case, any selected one of the datasets 118 always includes one or multiple types of basic data 122. Therefore, even without giving specific consideration, the user is able to cause a basic operation in which a basic object is imaged. While partly repeating description, the basic operation is any one of operations, such as “access to an index page of dataset”, “access to a support center for a supplier of the information presentation apparatus 100”, “access to a weather information site” for a predetermined district, and other operations desired many users. That is, the basic operation is defined to be an operation with high frequency of utilization by users.

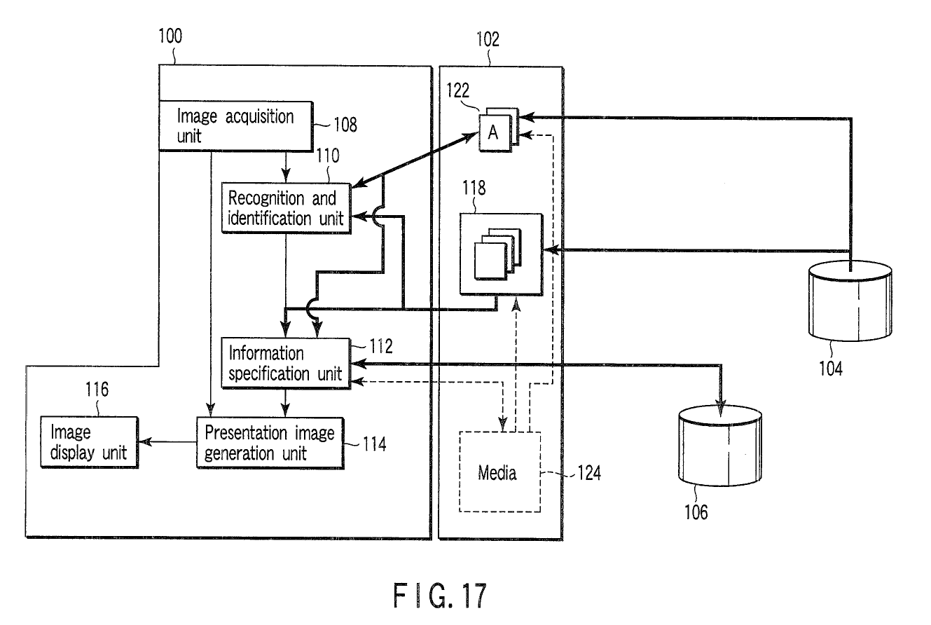

In addition, as shown in FIG. 17, the configuration can be such that in the event of activation of the information presentation apparatus 100, the dataset server 104 is connected, and the basic data 122 surely is downloaded and retained for another dataset 118, or is made referable simultaneously.

This configuration provides a method for admitting the basic data 122 useful in a configuration mode in which the dataset 118 is supplied as a separate resource, and especially, is downloaded through a network from the dataset server 104. More specifically, in the configuration shown in FIG. 17, in the event that a dataset 118 is to be supplied through a network to the information presentation apparatus 100, when the dataset 118 is to be selected by a user and is to be downloaded by the dataset server 104, also the basic data 122 can be concurrently automatically downloaded in addition to the dataset 118. Further, in the configuration shown in FIG. 17, in the case that the basic data 122 is already stored in the storage unit 102 of the platform having the information presentation apparatus 100, the basic data 122 can be updated.

Thereby, the user is able to always use the basic data 122 with the information presentation apparatus 100 without the need of giving special considerations.

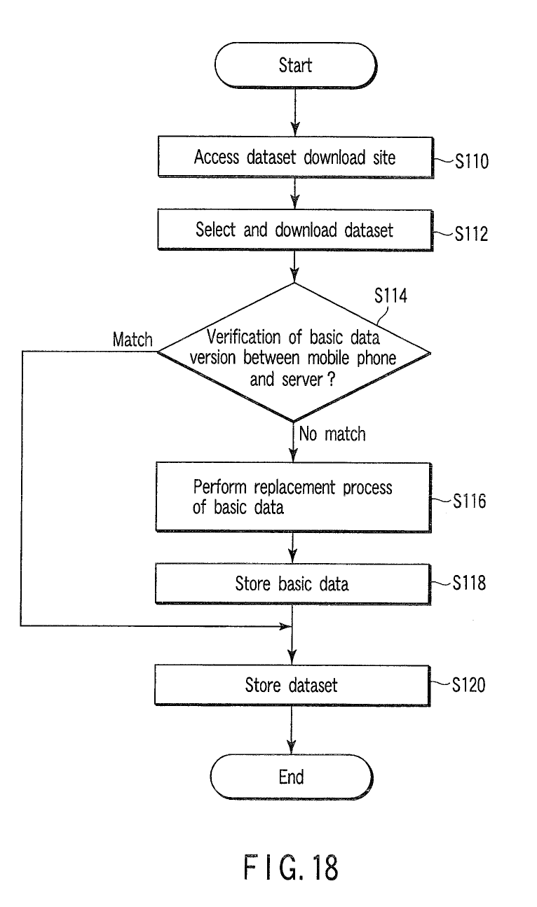

For example, in recent years, camera mobile phones capable of using application software are generally pervasive. A case is now contemplated in which a camera mobile phone of this type is used as a platform, and application software having functions, except those of the image acquisition unit 108 and image display unit 116 of the information presentation apparatus 100, is installed on the platform. With reference to FIG. 18, with the use of the application software, a predetermined dataset download site is accessed through communication of the mobile phone (step S110). Then, downloading is initially performed by the dataset server 104 (step S112). Subsequently, from the dataset server 104, it is determined whether an update of the basic data 122 is necessary (step S114).

If the basic data 122 does not exist in the mobile phone, it is determined that the update is necessary. In the event that, even while the basic data 122 already exists in the storage unit 102 of the mobile phone, if a version of the basic data 122 is older than a version of a basic data 122 intended to be supplied from the dataset server 104, it is determined that the update is necessary.

Subsequently, similarly to the case of the dataset 118, the basic data 122 is downloaded (step S116). The basic data 122 thus downloaded is stored into the storage unit 102 of the mobile phone (step S118). In addition, the dataset 118 downloaded is stored into the storage unit 102 of the mobile phone (step S120).

Thus, in the event that the basic data 122 already exists in the storage unit 102 of the mobile phone, the necessity of the update is determined through the version comparison, and then the basic data 122 is downloaded and stored.

As described above, regarding the necessity for the dataset 118, only a dataset 118 corresponding to the necessity of the user is stored into the mobile phone, whereby the securement of the object-identification process speed and user's necessity are made compatible.

The utilization range of the information presentation apparatus 100 includes, for example, access from the mobile phone to information relevant or attributed to a design of photograph or illustration of a publication, such as newspaper or magazine, as a object, and improvement of information presentation by superimposing the aforementioned information over an image acquired by the camera. Further, not only such the printout, but also any of, for example, physical objects and signboards existing in a town can be registered as an object into the features. In this case, such a physical object or signboard is recognized as an object by the mobile phone, thereby to make it possible to obtain additional information or latest information.

As another utilization mode using the mobile phone, in the case of a product, such as CD, DVD, or the like, having a package, the design of a jacket thereof is variant, and thus the respective jacket designs can be used as a object. For example, it is now assumed that data sets regarding such jackets are distributed to users from a store or separately from a record company. In this case, the respective jackets can be recognized as an object by the mobile phone in, for example, a CD and/or DVD store or rental store. As such, for example, a URL is correlated to the object, and audio distribution of, for example, a selected part of music can be implemented to the mobile phone as information correlated to the object through the URL. Further, as this correlated information, an annotation (respective annotation of a photograph of the jacket) corresponding to the surface of the jacket can be appropriately added.

Thus, as a utilization mode using the mobile phone, in the case of using a jacket design of a product such as CD, DVD, or the like having a package as the object, the arrangement can be made as follows. First, (1) at least a part of an exterior image of a recording medium containing music fixed thereto or a package thereof is preliminarily distributed to the mobile phone as object data. Then, (2) predetermined music information (such as audio data and annotation information) relevant to the fixed music is distributed to the mobile phone accessed to an address guided by the object.

The arrangement thus made is effective for promotion on the side of the record company, and produces an advantage in that, for example, time and labor can be reduced for preparation for viewing and listening on the side of the store.

As described above in each application, the recognition and identification unit, the information specification unit, the presentation image generation unit, and the position and orientation calculation unit are each implemented by a CPU, which is incorporated in the information presentation apparatus, and a program that operates on the CPU. However, this can be in another mode in which, for example, leased lines are provided.

As a mode for realizing the storage unit in the platform, an external data pack and a detachable storage medium (flash memory, for example) are usable, without being limited thereto.

Also in the second application, similarly as in the first application, the configuration can be formed to include the position and orientation calculation unit 120 so that relevant information is presented in accordance with calculated position and orientation.

In addition, as shown by the broken line in FIGS. 12 and 14 to 17, replaceable storage media 124 can be used instead of the dataset server 104 and/or the information server 106. In this case, the admission of data such as the dataset 118 and the basic data 122 to the storage unit 102 in the platform means expansion of data on internal memory from the replaceable storage media 124.

[Third Application]

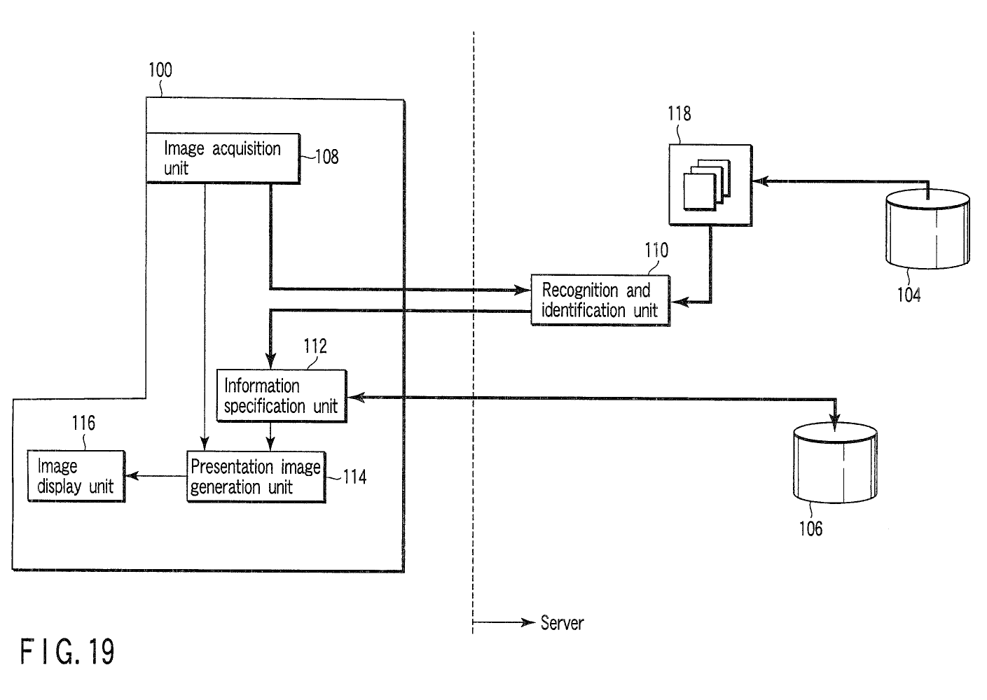

The configuration of the information retrieval system of the first application shown in FIG. 12 can be modified to a configuration shown in FIG. 19. More specifically, the recognition and identification unit 110 provided in the information presentation apparatus 100 and the dataset 118 provided in the storage unit 102 in the first application can, of course, be provided to the side of the server, as shown in FIG. 19. In the case that this configuration is used for the information retrieval system, the storage media 124 provided in the storage unit 102 is unnecessary, so that it is not provided.

[Fourth Application]

A fourth application will be described herebelow.

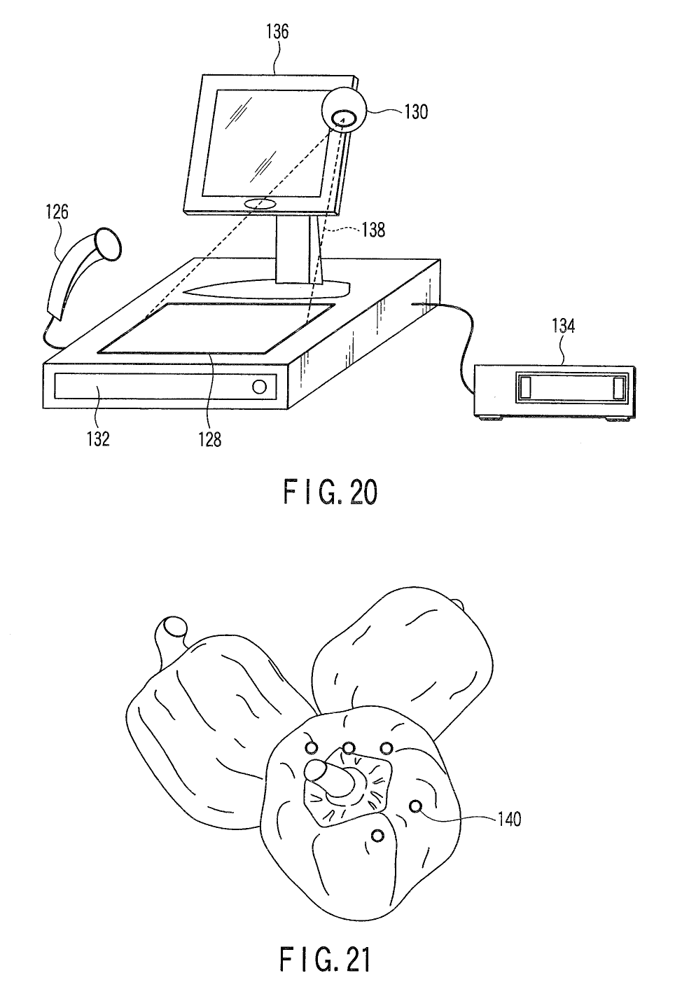

FIG. 20 is a view showing the configuration of a product recognition system of the fourth application.

The product recognition system includes a barcode scanner 126 serving as a reader for recognizing products each having a barcode, a weight scale 128 for measuring the weights of respective products, and in addition, a camera 130 for acquiring images of products. A control unit/cash storage box 132 for storing cash performs recognition of a product in accordance with a database 134 having registered product features for recognition, and displays the type, unit price, and total price of the recognized products on a monitor 136. A view field 138 of the camera 130 matches with the range of the weight scale 128.

Thus, according to the product recognition system, a system provider preliminarily acquires an image of an object that would need to be recognized, and registers a feature point extracted therefrom into the database 134. For example, for use in a supermarket, vegetables and the like such as tomato, apple, and green pepper are photographed, and feature points 140 thereof are extracted and stored, with identification indexes such as respectively corresponding recognition IDs and names, into the database 134 as shown in FIG. 21. In addition, by necessity, auxiliary information, such as an average weight and average size, of the respective objects is preliminarily stored into the database 134.

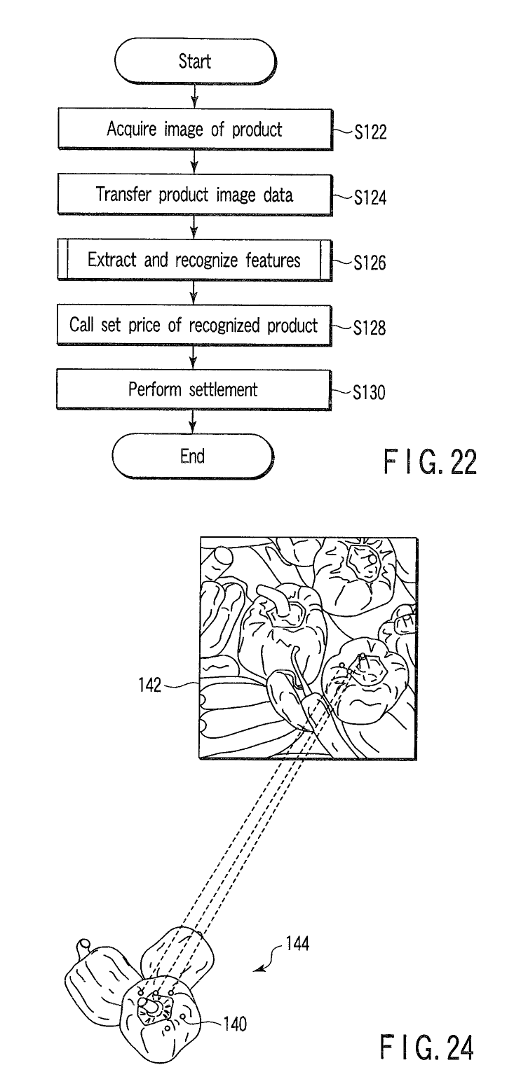

FIG. 22 is a flowchart of product settlement by the product recognition system of the fourth application.

A purchaser of a product carries the product (object) and places it within the view field 138 of the camera 130 installed to a cash register, whereby an image of the product is acquired (step S122). Image data of the product is transferred from the camera 130 to the control unit/cash storage box 132 (step S124). In the control unit/cash storage box 132, features are extracted, and the product is recognized with reference to the database 134 (step S126).

After the product has been recognized, the control unit/cash storage box 132 calls or retrieves a specified price of the recognized product from the database 134 (step S128), causes the price to be displayed on the monitor 136, and carries out the settlement (step S130).

In the event that a purchaser purchases two items, a green pepper and tomato, at first, an image of the tomato is acquired by the camera 130. Then, in the control unit/cash storage box 132, features in the image data are extracted, and matching with the database 134 is carried out. After matching, in the event that one object product is designated, a coefficient corresponding to the price thereof, or the weight thereof if a weight-based system is used, is read from the database 134 and is output to the monitor 136. Then, similarly, also for the green pepper, product identification and price display are carried out. Finally, a total price of the products are calculated and output to the monitor 136, thereby carrying out the settlement.

In the event that a plurality of object candidates exceeding a threshold value of similarity are output after matching, the following method is applied: (1) the candidates are displayed on the monitor 136 to be selected; or (2) re-acquiring of an image of an objects is carried out. Thereby, object establishment is carried out.

In the above, although the example is shown in which an image of each product is acquired one by one by the camera 130, an image including a plurality of object products can be acquired at one time for matching.

When purchasers carry out the processes, an automatic cash register can be realized.

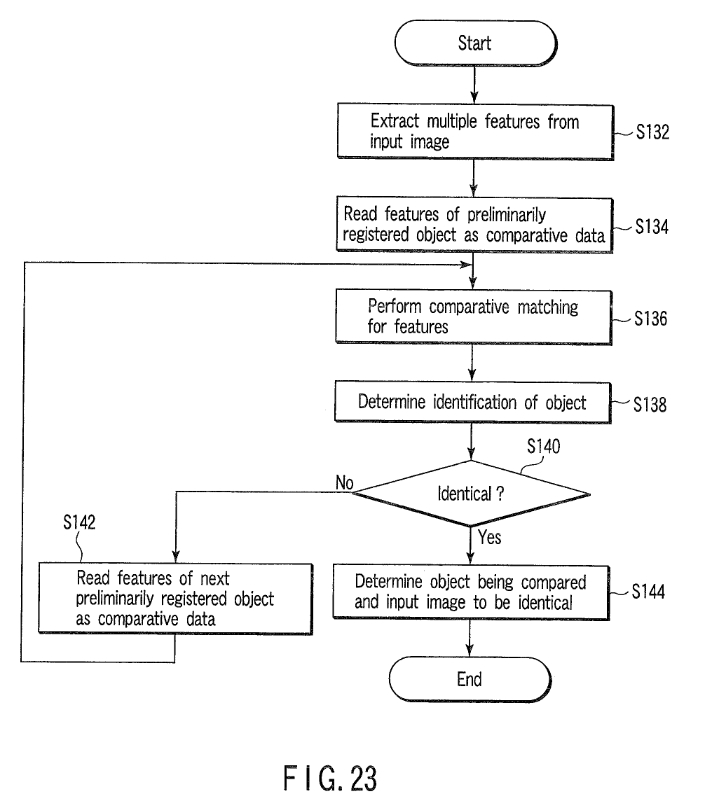

FIG. 23 is a flowchart of the feature extraction and recognition process in step S126 described above.

A plurality of features is extracted from an image (product image data) input from the camera 130 (step S132). Then, preliminarily registered features of object are read as comparison data from the database 134 (step S134). Then, as shown in FIG. 24, comparative matching between the features of an image 142 received from the camera 130 and the preliminarily registered features of a reference image 144 (step S136) is carried out, thereby to determine the identifiability of the object (step S138). If the object is determined to be not identical (step S140), features of a next preliminarily registered object are read from the database 134 as comparison data (step S142). Then, the operation returns to step S136.

Alternatively, if the object is determined to be identical (step S140), the object currently in comparison and the product in the input image are determined to be identical to one another (step S144).

As described above, according to the product recognition system of the fourth application, product recognition can be accomplished without affixing a recognition index such as barcode or RF tag to the product. Especially, this is useful as automatic recognition is possible in recognizing agricultural products, such as vegetables, and other products, such as meat and fish, for which significant time and labor are necessary to affix recognition indexes, unlike those such as industrial products to which recognition indexes can easily be affixed by printing and the like.

Further, objects to which such recognition indexes are less affixable include minerals, such that the system can be adapted for industrial use, such as automatic separation thereof.

[Fifth Application]

A fifth application will be described herebelow.

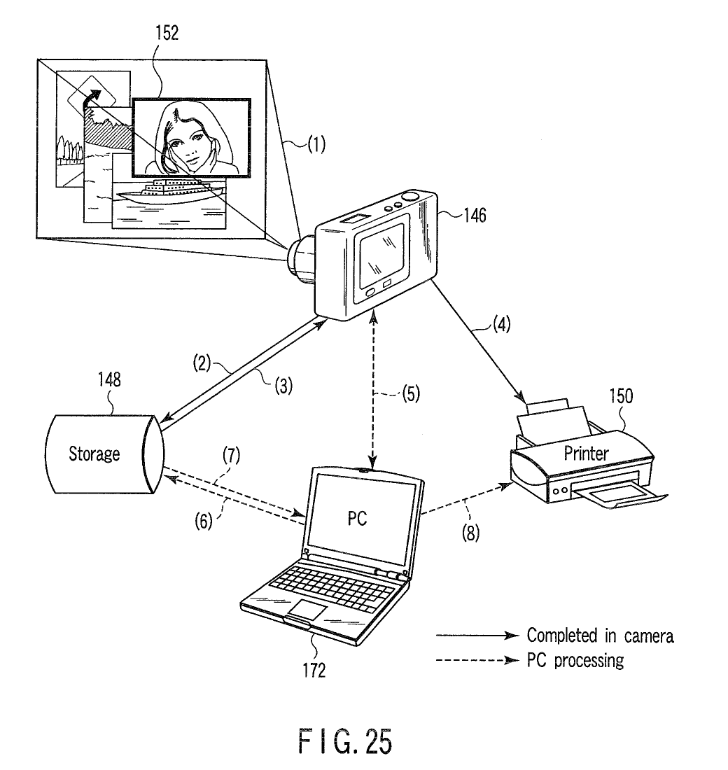

FIG. 25 is a view of an overall configuration of a retrieval system of the fifth application. As shown in the figure, the retrieval system includes a digital camera 146, a storage 148, and a printer 150. The storage 148 stores multiple items of image data. The printer 150 prints image data stored in the storage 148.

For example, the storage 148 is a memory detachable from or built in the digital camera 146. The printer 150 prints out image data stored in the memory, i.e., the storage 148, in accordance with a printout instruction received from the digital camera 146. Alternately, the storage 148 is connected to the digital camera 146 through connection terminals, cable, or wireless/wired network, or alternately, can be a device mounting a memory detached from the digital camera 146 and capable of transferring image data. In this case, the printer 150 can be of the type that connected to or is integrally configured with the storage 148 and that executes printout operation in accordance with a printout instruction received from the digital camera 146.

The storage 148 further includes functionality of a database from which image data is retrievable in accordance with the feature value. Specifically, the storage 148 configures a feature database (DB) containing feature sets created from digital data of original images.

The retrieval system thus configured performs operation as follows.

(1) First, the digital camera 146 acquires an image of a photographic subject including a retrieval source printout 152 once printed out by the printer 150. Then, a region corresponding to the image of the retrieval source printout 152 is extracted from the acquired image data, and features of the extracted region are extracted.

(2) Then, the digital camera 146 executes matching (process) of the extracted features with the feature sets stored in the storage 148.

(3) As a consequence, the digital camera 146 reads image data corresponding to matched features from the storage 148 as original image data of the retrieval source printout 152.

(4) Thereby, the digital camera 146 is able to again print out the read original image data with the printer 150.

The retrieval source printout 152 can use not only a printout having been output in units of one page, but also an index print having been output to collectively include a plurality of demagnified images. This is because it is more advantageous in cost and usability to select necessary images from the index print and to copy them.

The retrieval source printout 152 can be a printout output from a printer (not shown) external of the system as long as it is an image of which original image data exists in the feature DB.

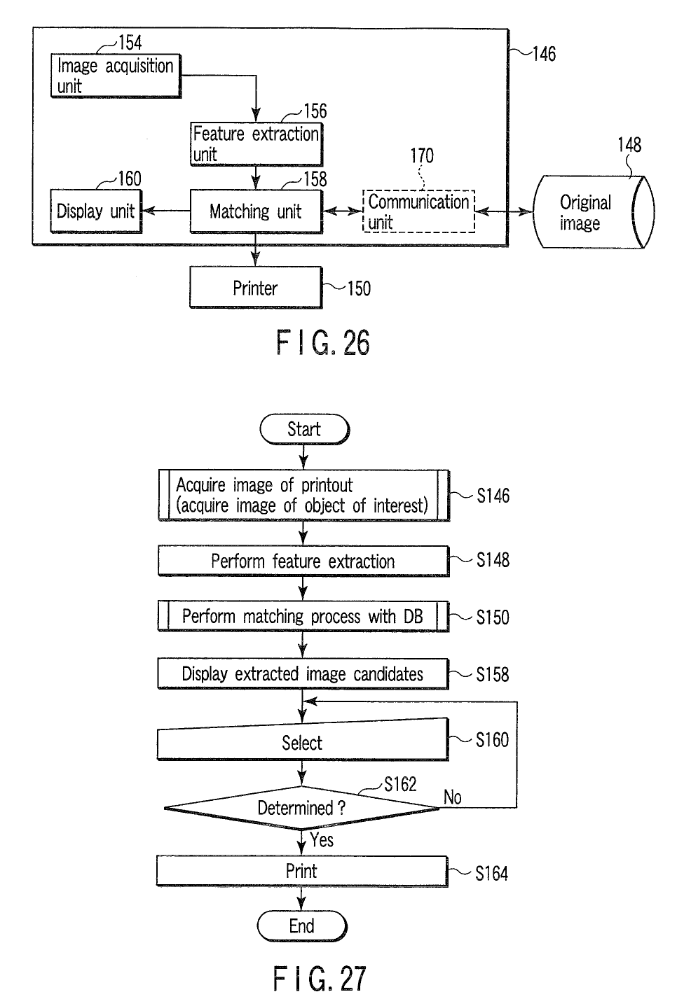

The retrieval system of the fifth application will be described in more detail with reference to a block diagram of configuration shown in FIG. 26 and an operational flowchart shown in FIG. 27. The digital camera 146 has a retrieval mode for retrieving already-acquired image data in addition to the regular imaging mode. The operational flowchart of FIG. 27 shows the process in the retrieval mode being set.

After having set the mode to the retrieval mode, a user operates an image acquisition unit 154 of the digital camera 146 to acquire image of a retrieval source printout 152 desired to be printed out again in the state where it is pasted onto, for example, a table or a wall face (step S146).

Then, features are extracted by a feature extraction unit 156 (step S148). The features can be any one of the following types: one type uses feature points in the image data; another type uses relative densities of split areas in the image data in accordance with a predetermined rule, that is, small regions allocated with a predetermined grating; another type in accordance with Fourier transform values corresponding to respective split areas. Preferably, information contained in such feature points includes point distribution information.

Subsequently, a matching unit 158 performs a DB-matching process in the manner that the features extracted by the feature extraction unit 156 are compared to the feature DB (feature sets) of already-acquired image data composed in the storage 148, and data with a relatively high similarity is sequentially extracted (step S150).

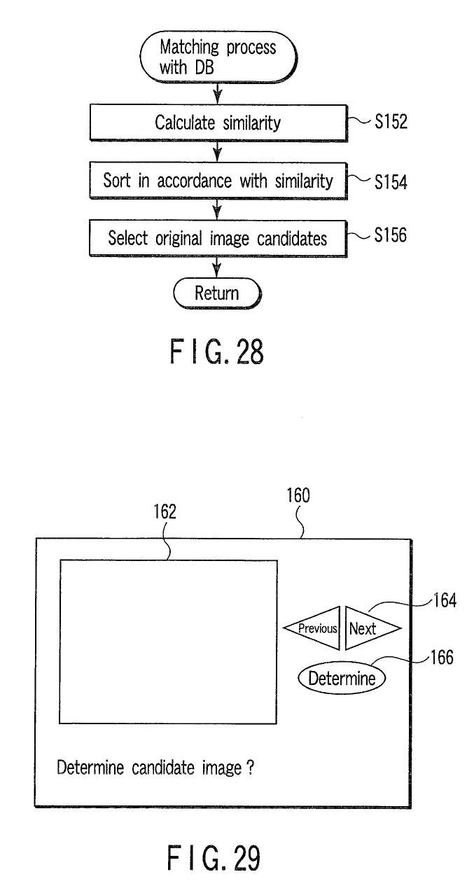

More specifically, as shown in FIG. 28, the DB-matching process is carried out as follows. First, similarities with features of respective already-acquired image data are calculated (step S152), and features are sorted in accordance with the similarities (step S154). Then, original image candidates are selected in accordance with the similarities (step S156). The selection can be done such that either threshold values are set or high order items are specified in the order of higher similarities. In either way, two methods are available, one for selecting one item with the highest similarity and the other for selecting multiple items in the order from those having relatively higher similarities.

Thereafter, image data of the selected original image candidates are read from the storage 148 and are displayed on a display unit 160 as image candidates to be extracted (step S158), thereby to receive a selection from the user (step S160).

FIG. 29 shows a display screen of the display unit 160 in the event of displaying only one image candidate. The display screen has “PREVIOUS” and “NEXT” icons 164 and a “DETERMINE” icon 166 on a side of a display field of an image candidate 162. The “PREVIOUS” and “NEXT” icons 164 represent a button that is operated to specify display of another image candidate. The “DETERMINE” icon 166 represents a button that is operated to specify the image candidate 162 as desired image data. The “PREVIOUS” and “NEXT” icons 164 respectively represent left and right keys of a so-called arrow key ordinarily provided in the digital camera 146, and the “DETERMINE” icon 166 represents an enter key provided in the center of the arrow key.

In the event that the arrow key, which corresponds to the “PREVIOUS” or “NEXT” icon 164 (step S162), is depressed, the process returns to step S158, at which the image candidate 162 is displayed. In the event that the enter key, which corresponds to the “DETERMINE” icon 166, is depressed (step S162), the matching unit 158 sends to the connected printer 150 original image data that corresponds to the image candidate 162 stored in the storage 148, and the image data is again printed out (step S164). When the storage 148 is not connected to the printer 150 through a wired/wireless network, the process of performing predetermined marking, such as additionally writing a flag, is carried out on the original image data corresponding to the image candidate 162 stored in the storage 148. Thereby, the data can be printed out by the printer 150 capable of accessing the storage 148.

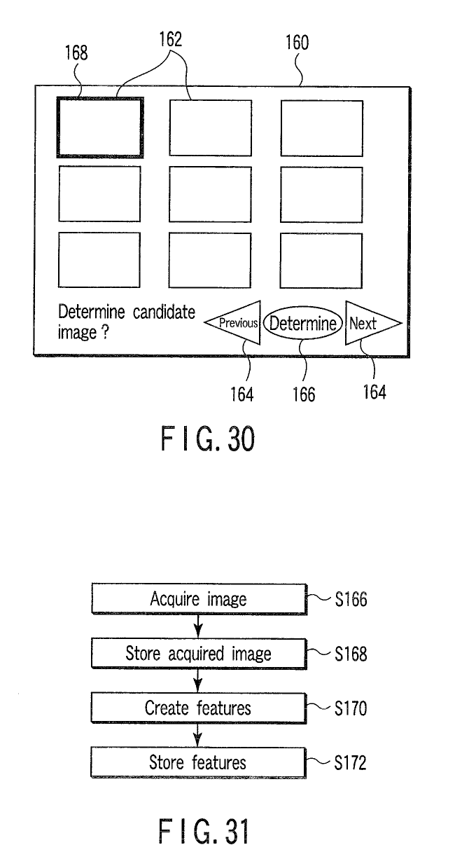

In step S158 of displaying the image candidate, a plurality of candidates can be displayed at one time. In this case, the display unit 160 ordinarily mounted to the digital camera 146 is, of course, of a small size of several inches, such that displaying of four or nine items is appropriate for use. FIG. 30 is view of a display screen in the event of displaying nine image candidates 162. In this case, a bold-line frame 168 indicating a selected image is moved in response to an operation of a left or right key of the arrow key, respectively, corresponding to the “PREVIOUS” or “NEXT” icon 164. Although specifically not shown, the arrangement may be such that the display of nine image candidates 162 is shifted, that is, so-called page shift is done, to a previous or next display of nine image candidates by operating an up or down key of the arrow key.

The feature DB of the already-acquired image data composed in the storage 148 as comparative objects used in step S150 has to be preliminarily created from original image data stored in the storage 148. The storage 148 can be either a memory attached to the digital camera 146 or a database accessible through a communication unit 170 as shown by a broken line in FIG. 26.

Various methods are considered for creation of the feature DB.

One example is a method that carries out calculation of features and database registration when storing acquired image data in the original-image acquiring event into a memory area of the digital camera 146. More specifically, as shown in FIG. 31, the digital camera 146 performs an image acquiring operation (step S166), and the acquired image data thereof is stored into the memory area of the digital camera 146 (step S168). Then, features are calculated from the stored acquired image data (step S170), and is stored in correlation with the acquired image data (step S172). Thus, in the case that the storage 148 is a built-in memory of the digital camera 146, a database is built therein. Alternatively, in the case that the storage 148 is a separate device independent of the digital camera 146, the acquired image data and features stored into the memory area of the digital camera 146 are both transferred into the storage 148, and a database is built therein.

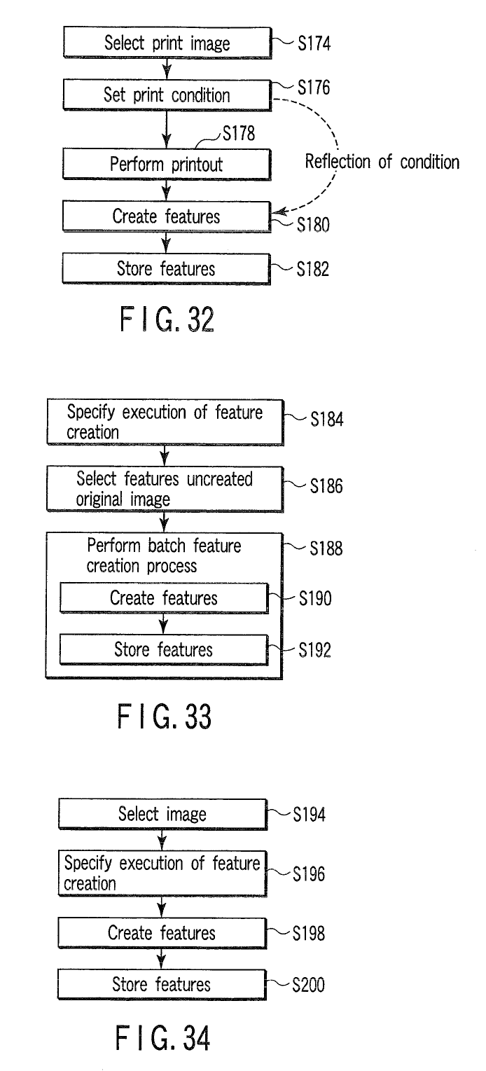

Another method is such that, when original image data stored in the storage 148 is printed out by the printer 150, printing-out is specified, and concurrently, feature extraction process is carried out, and the extracted features are stored in the database, therefore producing high processing efficiency. More specifically, as shown in FIG. 32, when printing out original image data stored in the storage 148, ordinarily, the original image data to be printed out is selected in response to a user specification (step S174); and printout conditions are set (step S176), whereby printing is executed (step S178). Ordinarily, the printing process is completed at this stage; however, in the present example, processing is further continued, thereby to calculate features from the selected original image data (step S180) and then to store features thereof in correlation with the original image data (step S180). In the event of creating the features, the printout conditions are reflected in the operation, thereby making it possible to improve matching accuracy between the retrieval source printout 152 and the features. According to the method, features are created only for original image data that may be subjected to the matching process, consequently making it possible to save creation time and storage capacity for unnecessary feature value data.

Further, of course batch processing can be performed. More specifically, as shown in FIG. 33, when a batch feature creation specification from a user is received (step S184), feature uncreated original image data in the storage 148 is selected (step S186), and a batch feature creation process is executed on the selected feature uncreated original image data (step S188). In the batch feature creation process, features are extracted from the respective feature uncreated original image data to create features (step S190), and the created features are stored into the storage 148 in correlation with the corresponding original image data (step S192).

Further, the data can be discretely processed in accordance with the input of a user specification. More specifically, as shown in FIG. 34, one item of original image data in the storage 148 is selected by the user (step S194), and creation of features for the selected original image data is specified by the user (step S196). Thereby, features are extracted from the selected original image data (step S198), and the features are stored into the storage 148 in correlation with the selected original image data (step S200). The specification for feature creation can be given by marking of a photograph desired to be printed out.

Conventionally, in many cases, when again printing out image data, which was previously printed out, a user retrieves the data with reference to supplementary information (such as file name and image acquired date/time) of the image data. However, according to the retrieval system of the present application, only by acquiring the image of the desired retrieval source printout 152 by using the digital camera 146, a file (image data) of the original image can be accessed, therefore making it possible to provide a retrieval method intuitive and with high usability for users.

Further, not only the original image data itself, but also image data similar in image configuration can be retrieved, thereby making it possible to provide novel secondary adaptabilities. More specifically, an image of a signboard or poster on the street, for example, is acquired in a so-called retrieval mode such as described above. In this case, image data similar or identical to the acquired image data can easily be retrieved from image data and features thereof existing in the storage 148, such as database, accessible through, for example, the memory attached to the digital camera 146 and communication.

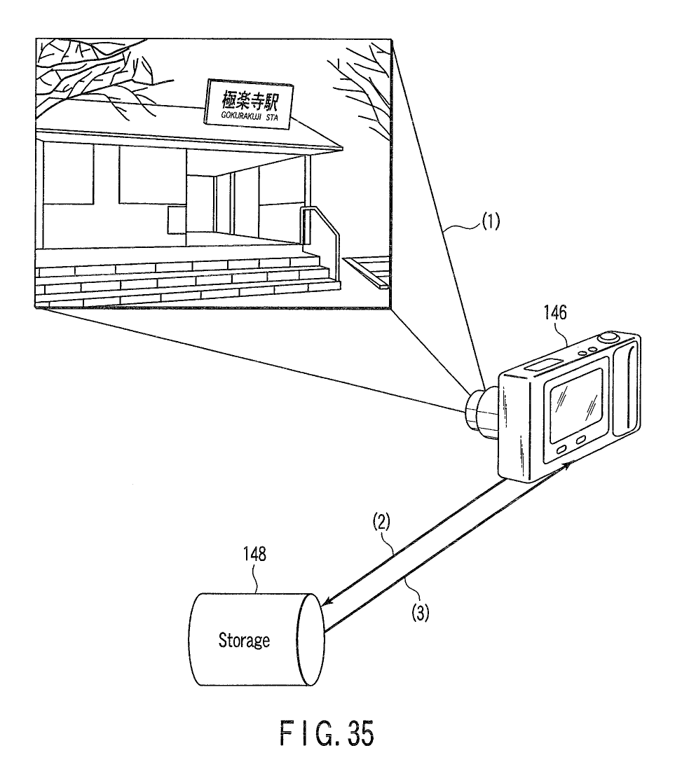

Further, suppose that, as shown in FIG. 35, for example, an image of a station name of a station as a sign board is acquired. In this event, the station name is recognized from image data thereof, thereby to make it possible to recognize the position of a photographer. Thus, recognized relevant information, such as peripheral portion of the recognized station, i.e., map information of the peripheral portion of the station, image information, and relevant character (letter) information, can be provided by being retrieved from relevant information existing in the storage 148, such as database, accessible through, for example, the memory attached to the digital camera 146 and communication. As a method of recognizing such a station name, there are available methods, such as those of character recognition, pattern recognition, recognition estimation based on retrieval of similar images, and these methods can be practiced by functions of the matching unit 43.

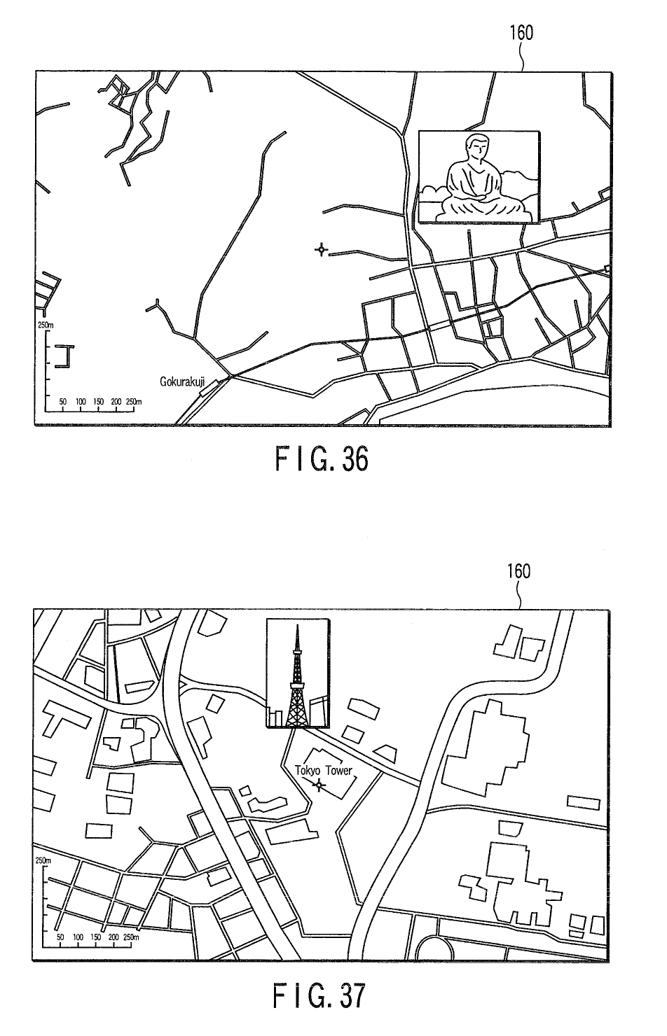

Further, an example case is assumed in which an image of the Tokyo Tower is acquired. In this case, images existing in the storage 148, such as database, accessible through, for example, the memory attached to the digital camera 146 and communication are retrieved, whereby photographs of not only the Tokyo Tower, but also photographs of tower-like buildings in various corners of the world can be retrieved and extracted. Further, in accordance with the position information provided as additional information of respective photographs thus retrieved and extracted, the locations of the respective towers can be informed, or as shown in FIGS. 36 and 37, displaying can be performed by superimposing the photograph over the location on a map. In this case, maps and photographs are relevant information.

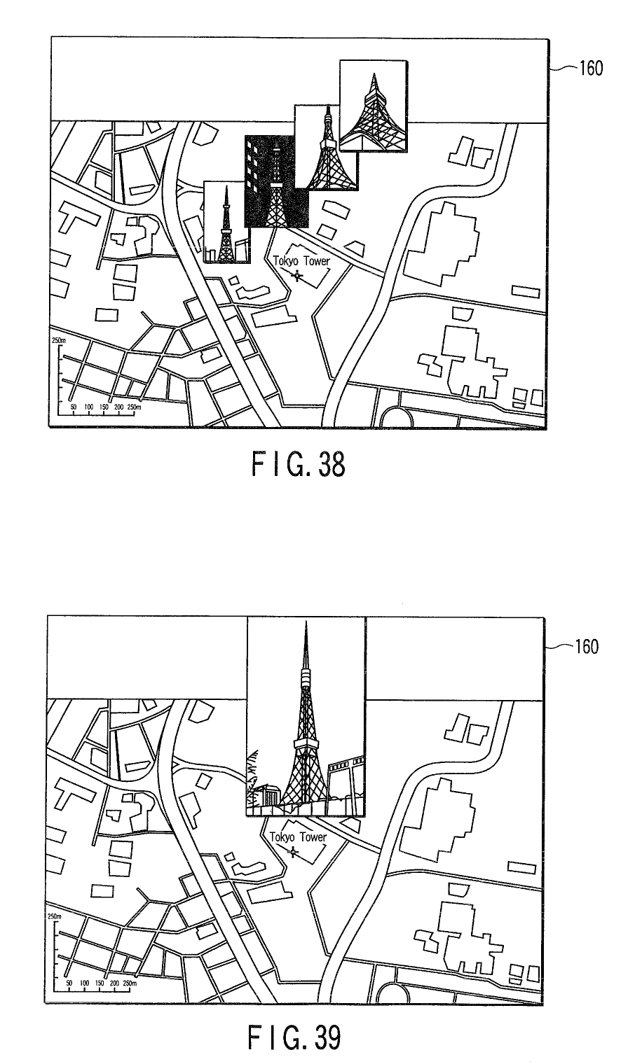

In the event of superimposed display of a photograph over a map, a case can occur in which many images are overlapped and less visible depending on factors, such as the map scale, the photograph size, the number of photographs relevant to the location. In such a case, as shown in FIG. 38, technical measures are taken such that, for example, the display size of photograph is changed corresponding to the map scale; and as shown in FIG. 39, in the event of a large number of photographs, only one representative photograph is displayed instead of displaying photographs in the display size proportional to the number of photographs. Alternatively, there can be displayed only one photograph representative of a collective set that can become less visible because the photographs are superimposed on one another or are collected at excessively high density. Such a representative photograph is selectable from various viewpoints, such as highest similarity and most frequently viewed among those in the set.

In the above, although it has been described that the process of steps S148 to 5162 is carried out within the digital camera 146, the process can be carried out in a different way as follows. In the case where the storage 148 is provided as a separate resource independent of the digital camera 146, the process described above can be actually operated by being activated in the form of software in the storage 148 or by being separated into the digital camera 146 and the storage 148.

[Sixth Application]

An outline of a retrieval system of a sixth application will be described herebelow with reference to FIG. 25.

The retrieval system includes a digital camera 146, a storage 148, a printer 150, and a personal computer (PC) 172. The storage 148 is a storage device built in the PC 172 or accessible by the PC 172 through communication. The PC 172 is wired/wireless connected to the digital camera 146, or alternatively is configured to permit a memory detached from the digital camera 146 to be attached, thereby being able to read image data stored in the memory of the digital camera 146.

The retrieval system thus configured performs operation as follows.

(1) First, the digital camera 146 acquires an image of a photographic subject including a retrieval source printout 152 once printed out by the printer 150.

(5) The PC 172 extracts a region corresponding to the image of the retrieval source printout 152 from the image data acquired, and then extracts features of the extracted region.

(6) Then, the PC 172 executes matching process of the extracted features with the features stored in the storage 148.

(7) As a consequence, the PC 172 reads image data corresponding to matched features as original image data of the retrieval source printout 152 from the storage 148.

(8) Thereby, the PC 172 is able to again print out the read original image data by the printer 150.

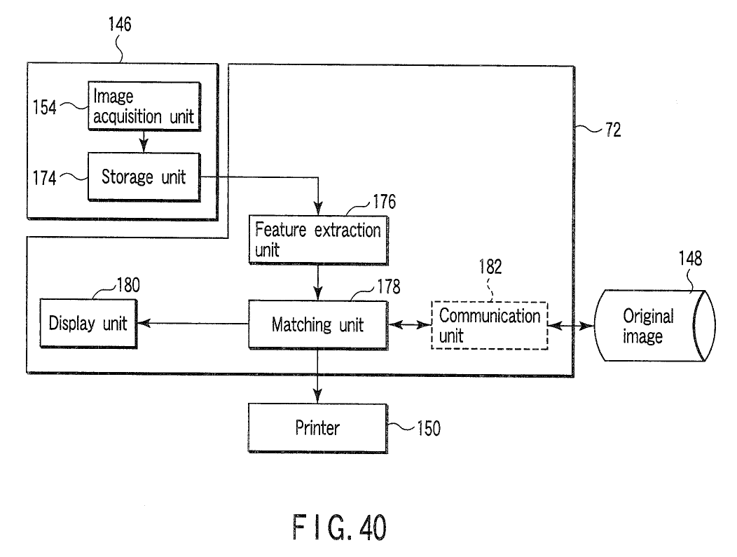

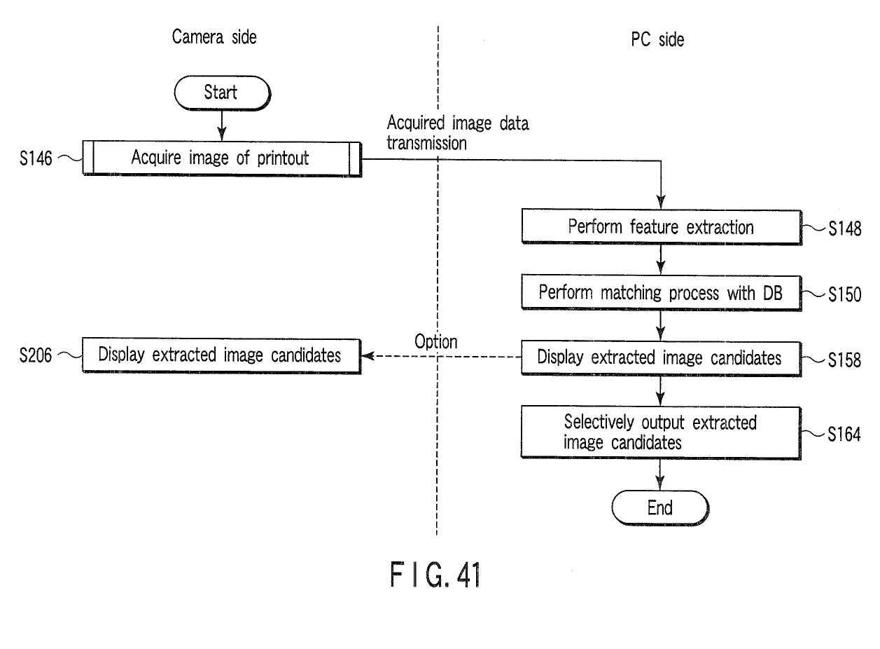

The retrieval system of the sixth application will be described in more detail with reference to a block diagram of configuration shown in FIG. 40 and an operational flowchart shown in FIG. 41. In these figures, the same reference numerals designate the portions corresponding to those of the fifth application.

The present application contemplates a case where image data acquired by the digital camera 146 is stored into the storage 148 built in or connected to the PC 172 designated by a user, and a process shown on the PC side in FIG. 41 operates in the PC 172 in the form of application software. The application software is activated in the state that the PC 172 and the digital camera 146 are hard wired or wirelessly connected together thereby to establish a communication state. The state may be such that functional activation is carried out through the operation of tuning on a switch such as a “retrieval mode” set for the digital camera 146.

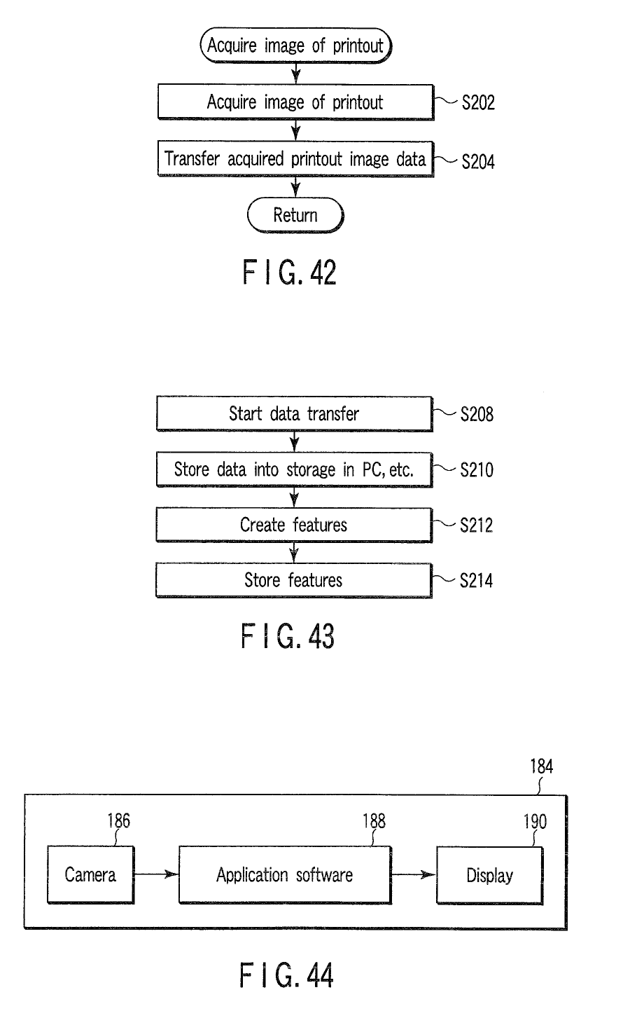

With the application software having thus started the operation, an image acquisition process for acquiring an image of a printout is executed on the side of the digital camera 146 (step S146). More specifically, as shown in FIG. 42, a user operates an image acquisition unit 154 of the digital camera 146 to acquire an image of a retrieval source printout 152 desired to be again printed out in the state where it is pasted onto, for example, a table or a wall face so that at least no omission of the retrieval source printout 152 occurs (step S202). Thereby, acquired image data is stored into a storage unit 176 serving as a memory of the digital camera 146. Then, the acquired image data thus stored is transferred to the PC 172 hard wired or wirelessly connected (step S204).

Then, in the PC 172, a feature extraction unit 176 realized by application software performs the process of extracting features from the transferred acquired image data (step S148). The feature extraction process can be performed on the digital camera 146 side. Thereby, the amount of communication from the digital camera 146 to the PC 172 can be reduced.

Subsequently, a matching unit 178 realized by application software performs a DB-matching process such that the extracted features are compared to the feature DB of already-acquired image data composed in the storage 148, and those with relatively high similarities are sequentially extracted (step S150). More specifically, in accordance with the calculated features, the matching unit 178 on the PC 172 side performs comparison with the features stored in correlation to respective items of image data in the storage 148 (or, comprehensively stored in the form of a database), and most similar one is selected. It is also effective in usability to set such that a plurality of most similar feature candidates is selected. The features include specification information of original image data from which the features have been calculated, and candidate images are called in accordance with the specification information.

Thereafter, image data of the selected original image candidates (or candidate images) are read from the storage 148 and are displayed on a display unit 180 serving as a display of the PC 172 as image candidates to be extracted (step S158), whereby to receive a selection from the user. In this case, the processing may be such that the selected original image candidates (or the candidate images) are transferred as they are or in appropriately compressed states from the PC 172 to the digital camera 146, and are displayed on the display unit 160 of the digital camera 146 (step S206).

Then, in response to a selection performed through the operation of a mouse or the like, original image data corresponding to the image candidate stored in the storage 148 is sent to the connected printer 150 and is printed thereby (step S164). More specifically, the displayed original image candidate is determined through determination of the user and is passed to the printing process, thereby to enable the user to easily perform the preliminarily desired reprinting of already-printed image data. In this event, not only printing is simply done, but also the plurality of selected candidate images result in a state that “although different from the desired original image, similar images have been collected”, depending on the user's determination, thereby realizing the function of batch retrieval of similar image data.

In the present application, the feature DB can be created in the event of transfer of the acquired image data from the digital camera 146 to the storage 148 through the PC 172. More specifically, with reference to FIG. 43, transfer of the acquired image data from the digital camera 146 to the PC 172 is started (step S208). Then, by using the PC 172, the transferred acquired image data is stored into the storage 148 (step S210), and the features are created from the acquired image data (step S212). Then, the created features are stored into the storage 148 in correlation with the acquired image data (step S214).

Thus, according to the sixth application, similarly to the fifth application, only by acquiring the image of the desired retrieval source printout 152 by using the digital camera 146, a file (image data) of the original image can be accessed, thereby making it possible to provide a retrieval method intuitive and with high usability for users.

Further, not only the original image data itself, but also image data similar in image configuration can be retrieved, thereby making it possible to provide novel secondary adaptabilities. More specifically, an image of a signboard or poster on the street, for example, is acquired in a so-called retrieval mode such as described above. In this case, image data similar or identical to the acquired image data can easily be retrieved from image data and features thereof existing in the storage 148, such as an external database, accessible through, for example, the memory attached to the digital camera 146 and a communication unit 182 shown by the broken line in FIG. 40. Further, Internet sites associated to the data can be displayed on the displays of, for example, the PC 172 and digital camera, and specific applications (for audio and motion images (movies), for example) can be operated.

Description has been given with reference to the case where the digital camera 146 is used, the present application is not limited thereto, and a scanner can be used.

Further, while an image of the retrieval source printout 152, which has actually been printed out, is acquired by the digital camera 146, an image of a display displaying the acquired image of the retrieval source printout 152, for example, can be acquired by the digital camera 146.

[Seventh Application]

A retrieval system of a seventh application will be described herebelow. The present application is an example of adaptation to application software 188 of a mobile phone 184 with a camera 186, as shown in FIG. 44.

Mobile phone application software is at present usable with most mobile phones, and a large number of items of image data are storable in a memory such as an internal memory or an external memory card. Further, in specific mobile phone sites (mobile phone dedicated Internet sites), storage services for, for example, user-specified image files are provided. In these environments, a very large number of image data can be stored, thereby to make it possible to use them for various user's own activity recording and jobs. On the other hand, however, retrieval of desired image data is complicate and burdensome for hardware of the mobile phone having the interface relatively inferior in freedom degree. In most cases, actual retrieval is carried out from a list of texts representing, for example, the titles or date and time of image data. As such, it must be said that, in the case of large number of image data, the retrieval is complicate and burdensome; and even when keying-in a text, it is inconvenient to input a plurality of words or a long title, for example.

According to the present retrieval system installed, the system is operated as the application of the camera mobile phone, thereby to carry out the activation of “image input function”, “segmentation of a region of interest”, and “feature calculation.” The features are transmitted to a corresponding server via a mobile phone line. The corresponding server can be provide in a one to one or one to multiplicity relation with respect to the camera or cameras. The features sent to the server are actually subjected to the process of matching by a “matching function” provided in the server with the features read from a database required by the server. Thereby, image data with high similarity is extracted. The image data thus extracted is returned to the call-side mobile phone from the server, whereby the image data can be output by a printer unspecified from the mobile phone. In the case that various types of information relevant to the image data are further added to the image data extracted by the server, an extended function “the information is returned to the mobile phone” can be implemented. Further, the extracted image data is highly compressed and returned to the mobile phone, and after a user verifies that the data is a desired image data, the data is stored in the memory area of the mobile phone or is displayed on a display 190 of the mobile phone. Even only from this fact, it can of course be said that the system is useful.

[Eighth Application]

A retrieval system of an eighth application will be described herebelow.

The present application has a configuration including a digital camera 146 with a communication function and a server connected through communication, in which a function for image retrieval is sharedly provided to the digital camera 146 and the server. The digital camera 146 with the communication function provides the function as an image-acquiring-function mounted communication device, and of course includes a camera mobile phone.

In this case, similarly as in the fifth application, the digital camera 146 includes the image acquiring function and a calculation function for calculating the features from the image data. In any one of the fifth to seventh applications, the features (or the feature DB) to be compared and referred are originally created based on images acquired and printed out by users or the digital camera 146. This is attributed to the fact that the initial purpose is to image printouts of already-acquired image data and to carry out retrieval. In comparison, the present application is configured by extending the purpose and is significantly different in that features calculated based on images of, for example, on-the-street sign boards, posters, printouts, and publications are also stored into the database formed in the storage 148 of the server.

Of course, not only printing out, but also extraction from images contained in the database can be accomplished.

Further, features extracted from an acquired image can be added to the database.

In the event of registration, position information relevant to the image is recognized manually, by a sensor such as a GPS, or by the above-described character recognition, and then is registered. In this manner, in the event of acquiring a next time image in a similar location, a similar image is extracted by retrieval from the database, whereby the position information desired to be added to the acquired image can be extracted.

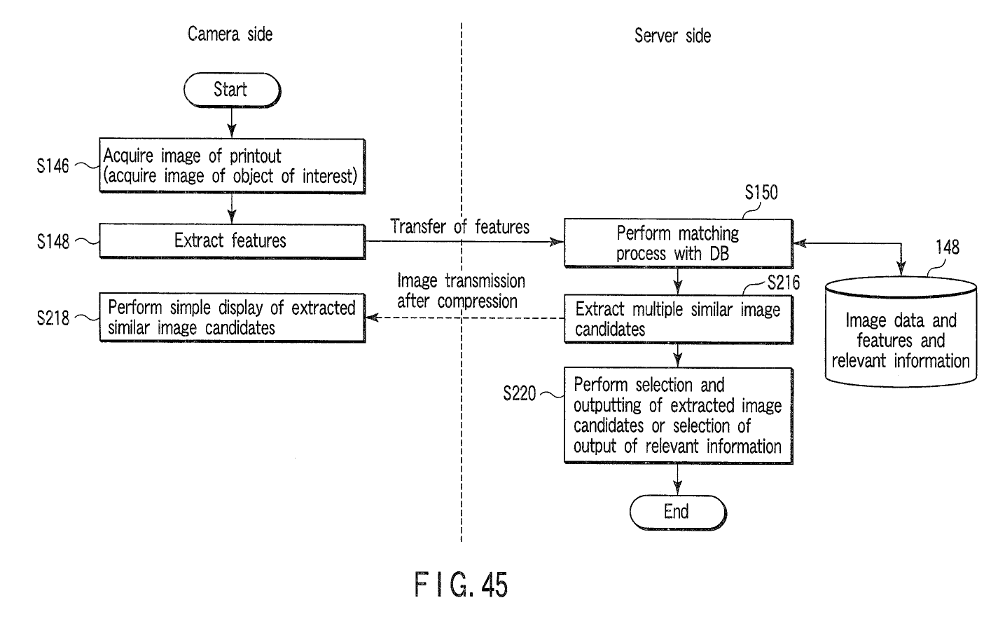

FIG. 45 is a flowchart showing operation of the retrieval system of the present application. In the figure, the same reference numerals designate the portions corresponding to those in the fifth application.

In the present application, an image of a poster such as a product advertisement present on the street is acquired by the digital camera 146, for example (step S146). Then, a feature extraction process is executed by the digital camera 146 from the acquired image data (step S148). The extracted features are sent to a predetermined server by the communication unit 170 built in or attached to the digital camera 146.

In the server, the feature DB formed in the storage 148 accessible by the server is looked up (accessed), and features sent from the digital camera 146 are compared thereto (step S150), thereby to extract similar image candidates having similar features (step S216). Image data of the extracted similar image candidates are, by necessity, subjected to a predetermined compression process to reduce the amount of communication, and then are sent to the digital camera 146, whereby the candidates can be simply displayed on the display unit 160 of the digital camera 146 (step S218). Thereby, user selection can be performed similarly as in the fifth application.

Then, image data of an image candidate extracted (and selected) is sent and output to the digital camera 146; or alternatively, a next operation is carried out in accordance with specified information correlated to the features of the extracted (and selected) image candidate (step S220). In the case of the product advertisement, the next operation can be, for example, description of the product or connection to a mail-order site or returning of a screen of the site, as image data, to the digital camera 146. Further, in the event that an image of an on-the-street signboard has been acquired, also peripheral information of the signboard is retrieved as features. Further, for example, data of the location of a wireless communication base station during communication is compared, thereby to make it possible to present identifications of, for example, the location and address, as information to the user.

[Ninth Application]

A retrieval system of a ninth application will be described herebelow.

The present application retrieves multiple items of image data from a storage 148 by matching using first features in accordance with an acquired image of an acquired retrieval source printout 152. In addition, the application retrieves a single or multiple items of image data from the multiple items of image data, obtained as a result of the retrieval by feature matching using second features of a region narrower than or identical to the first features and high in resolution.

The retrieval system of the present application has a configuration similar to that of the fifth application. Particularly, in the present application, the storage 148 is configured to include a total feature DB containing general features registered as first features, and a detail feature DB containing detail features registered as second features.

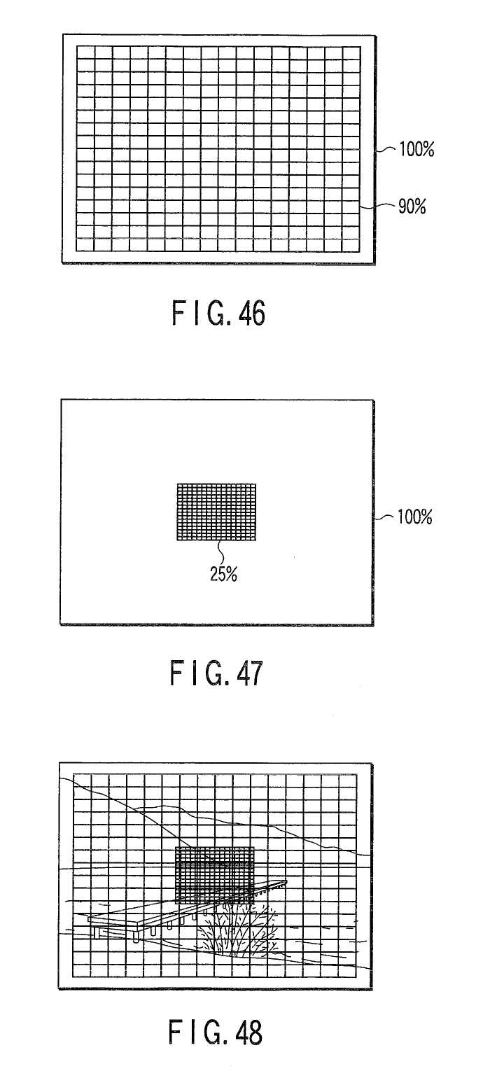

As shown in FIG. 46, the general features are obtained by extraction of a region containing most (about 90%, for example) of the totality (100%) of image data at a relatively coarse (low) resolution. As shown in FIG. 47, the detail features are obtained by extraction of a region containing a central region portion (about central 25%, for example) of the image data at a high resolution relative to the resolution of the general features. The positional relationship between the original image data and the general features and the detail features is shown in FIG. 48.

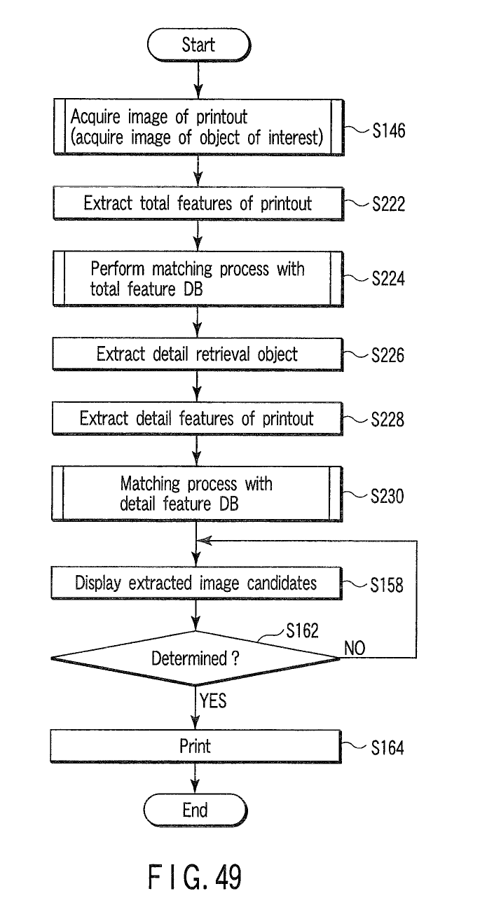

FIG. 49 is a flowchart showing operation of the retrieval system of the present application. In the diagram, the same reference numerals designate the portions corresponding to those in the fifth application.

Similarly as in the fifth application, in the present application, first, an image acquisition unit 154 of a digital camera 146 set in a retrieval mode acquires an image of a retrieval source printout 152 desired to be printed out again in the state where it is pasted onto, for example, a table or a wall face so that at least no omission of the retrieval source printout 152 occurs (step S146).

Then, a total feature extraction process for extracting features from the totality of the image data acquired by the image acquisition unit 154 is performed by a feature extraction unit 156 (step S222). Then, a matching process with the total feature DB, which compares the extracted total features to the total feature DB composed in the storage 148 and containing registered general features and sequentially extracts data with a relatively high similarity, is executed by a matching unit 158 (step S224).

Thereafter, in the feature extraction unit 156, a detail retrieval object region, namely image data of the central region portion of the region of interest in the present example, is further extracted as detail retrieval object image data from the acquired image data of the total region of interest (step S226).

Then, a detail feature extraction process for extracting features from the extracted detail retrieval object image data is performed by the feature extraction unit 156 (step S228). Subsequently, in the matching unit 158, a matching process with the detail feature DB, which compares the extracted detail features to the detail feature DB formed in the storage 148 and having registered detail features and sequentially extracts data with higher similarity, is executed (step S230). In this case, however, feature matching with all detail features registered into the detail feature DB is not performed, but feature matching is executed only for detail features corresponding to multiple items of image data extracted by the matching process with the total feature DB in the step 5224. Therefore, although the feature value matching process with the detail features takes a process time by nature as the resolution is high, the process can accomplished within a minimum necessary time. As a criterion for the extraction in the matching process with the total feature DB in step S224, such a method is employed that provides a threshold value for the similarity or that fixedly selects high order 500 items.

After the image data with high similarity are extracted as original image candidates by the matching process with the detail feature DB, the candidates are displayed on the display unit 160 as image candidates for extraction (step S158), thereby to receive a selection from the user. If an image desired by the user is determined (step S162), then the matching unit 158 sends original image data corresponding to the image candidate stored in the storage 148 to the connected printer 150; and the data is again printed out (step S164).

According to the present application, quality (satisfaction level) of the retrieval result of the original image data and an appropriate retrieval time period are compatible with one another.

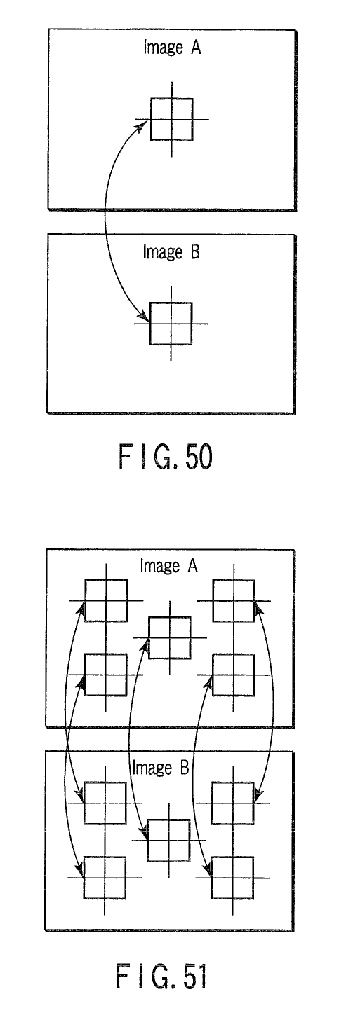

Further, the retrieval result incorporating the consideration of the attention region for the photographer can be obtained. More specifically, ordinarily, the photographer acquires an image of a main photographic subject by capturing it in the center of the imaging area. Therefore, as shown in FIG. 50, the detail features with attention drawn to the center of the image data are used to obtain a good retrieval result. Accordingly, in the system in which original image data is retrieved and extracted from retrieval source printout 152, which is the printed out photograph, and copying thereof is easily performed, the effectiveness is high in retrieval of the printed photograph.

Further, in retrieval from an original image population for which keyword classification and the like are difficult, the effectiveness as means for performing high speed determination of small differences is high. That is, the retrieval result can be narrowed down in a stepwise manner with respect to a large population.

Also in the present application, the general features and the detail features have to be preliminarily created and registered into the database for one item of original image data. The registration can be performed as described in the fifth application. However, both the features do not necessarily have to be created at the same time. For example, the method can be such that the detail features are created when necessary in execution of secondary retrieval.

Further, the features are not limited to that as shown in, for example, FIG. 47 or 50, which draws attention to the central portion.

For example, as shown in FIG. 51, features can be set in several portions of the image. Failure due to a print-imaging condition can be prevented by thus distributively disposing features. Thereby, convergence can be implemented by dynamically varying, for example, the positions and the number of features.

Further, as shown in FIG. 52, the detail features may be such that an attention region can be placed in a focus position in the event of acquiring an original image. With such detail features, a result reflecting the intention of a photographer can be expected.

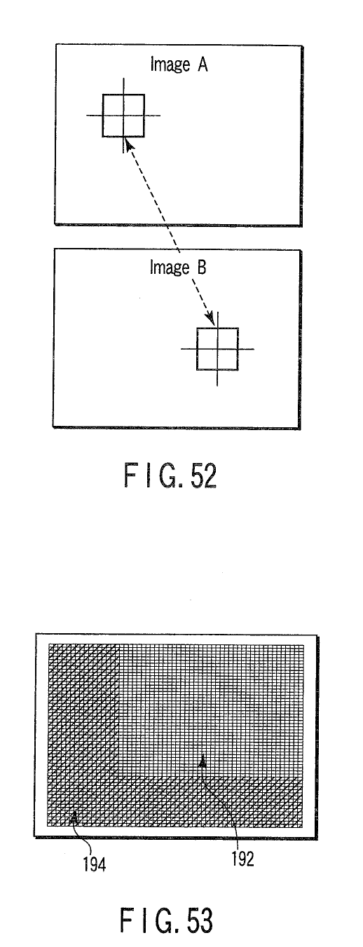

Further, as shown in FIG. 53, detail features are created in a region identical to that of general features and are registered into the database.

Thereby, in the event of feature matching with the detail features, a partial region thereof, that is, the region as shown in each of FIGS. 50 to 52 is used as a reference region 192, and the other region is used as a non-reference region 194.

Although the present application has thus been described in correspondence to the fifth application, the application is, of course, similarly adaptable to the sixth to eighth applications.

[Tenth Application]

A retrieval system of a tenth application will be described herebelow.

The retrieval system of the present application is an example using a digital camera 146 including a communication function. The application is adapted in the case where a preliminarily registered image is acquired to thereby recognize the image, and a predetermined operation (for example, activation of an audio output or predetermined program, or displaying of a predetermined URL) is executed in accordance with the recognition result. Of course, the digital camera 146 with the communication function functions as an imaging-function mounted communication device, and includes a camera mobile phone.

When an image is recognized, while image data is registered as a reference database (so-called dictionary data), it is more efficient and practical to compare the features of images than to compare the images as they are, such that a feature value database (DB) of features extracted from images is used. The database can be of a built-in type or a type existing in the server through communication.

In the present application, an arrangement relationship of feature points of an image is calculated as a combination of vector quantities, and a multigroup thereof is defined to be the feature. In this event, the feature is different in accuracy depending on the number of feature points, such that as the fineness of original image data is higher, a proportionally larger number of feature points are detectable. As such, for the original image data, the feature is calculated under a condition of a highest-possible fineness. In this event, when the feature is calculated for the same image element in accordance with image data with a reduced fineness, the number of feature points is relatively small, such that the feature itself has a small capacity. In the case of a small capacity, while the matching accuracy is low, advantages are produced in that, for example, the matching speed is high, and the communication speed is high.

In the present application, attention is drawn on the above-described. More specifically, in the event of registration of image data as reference data (feature), when one image element is registered, the features are calculated from a plurality of different finenesses, thereby to configure databases specialized corresponding to the respective finenesses.

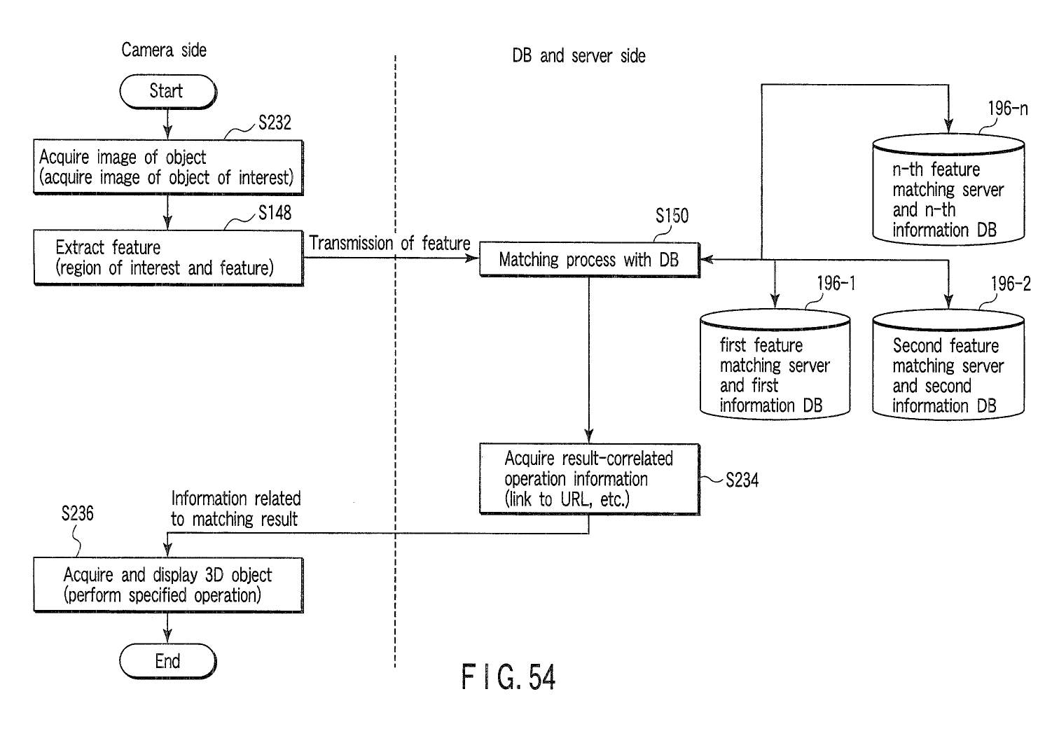

Corresponding matching servers are connected to the respective databases and arranged to be capable of providing parallel operation. More specifically, as shown in FIG. 54, a first feature matching server and first information DB 198-1, a second feature matching server and second information DB 198-2, . . . , and an n-th feature matching server and n-th information DB 198-n are prepared. The second feature matching server and second information DB 198-2 to the n-th feature matching server and n-th information DB 198-n are each a database having features with higher fineness or in a special category in comparison to the first feature matching server and first information DB 198-1.

With the matching process system thus prepared, as shown in FIG. 54, an image of a design (object) already registered is acquired by the communication function mounted digital camera 146 (step S232). Then, feature is calculated from the arrangement relationship of the feature points by application software built in the digital camera 146 (step S148). Then, the feature is transmitted to the respective matching servers through communication, whereby matching process with the respective DBs is carried out (step S150). In the event that a matching result is obtained by the matching process, then operation information (such as a URL link) correlated to the result is obtained (step S234), and the operation information is transmitted to the digital camera 146, whereby a specified operation, such as displaying of 3D object acquirement, is performed (step S236). Of course, the digital camera 146 can transmit whole or part of acquired image to the matching servers, whereby step 5148 can be executed in the matching servers.

In this event, suppose that the camera resolution is about two million pixels. In this case, also when performing retrieval in the matching server through communication, if matching is performed by using data from a feature DB having a resolution of about two million pixels, an erroneous-recognition ratio is low.

However, matching in a concurrently operating feature DB with a low resolution (VGA class resolution, for example) is responsive at high speed, and thus the result is transmitted earlier to the digital camera 146. It is advantageous in speed and recognition accuracy to thus parallel arrange the matching servers corresponding to the resolutions. However, a case can occur in which a response (result) from the followingly operating high-resolution matching server is different from an already-output result of the low-resolution matching server. In such a case, displaying in accordance with the earlier result is first carried out, and then it is updated to a display in accordance with the following result. In the event of recognition of, for example, a banknote, although the result in the low resolution matching is a level of “$100 note”, a more detailed or proper result, such as “$100 note with the number HD85866756A”, due to the higher fineness can be obtained in the high resolution matching. In addition, a displaying manner is also effective in which a plurality of candidates are obtained from the low resolution result, and the resultant candidates are narrowed down to be accurate as a high resolution result arrives.

In addition, as described above, the capacity of the feature itself is large in the high resolution matching server. A feature in an XGA class increases to about 40 kB; however, the capacity is reduced to about 10 kB by preliminary low resolution matching.

Further, in the second or higher matching server and database, when only a difference from a lower low resolution database is retained, a smaller database configuration is realized. This leads to an increase in the speed of the recognition process. It has been verified that, when extraction with feature (method in which area allocation is carried out, and respective density values are compared) is advanced for features, the feature is generally 10 kB or lower, and also multidimensional features obtained by combining the two methods appropriately are useful to improve the recognition accuracy.

As described above, the method in which the resolution of some or entirety of the acquired image surface is divided into multiple resolutions to thereby realize substantial matching hierarchization is effective in both recognition speed and recognition accuracy in comparison with the case in which a plurality of matching servers are simply distributed in a clustered manner.

Especially, the above-described method is a method effective in the case that the number of images preliminarily registered into a database is very large (1000 or larger), and is effective in the case that images with high similarity are included therein.

[Eleventh Application]

A retrieval system of an eleventh application will be described herebelow.

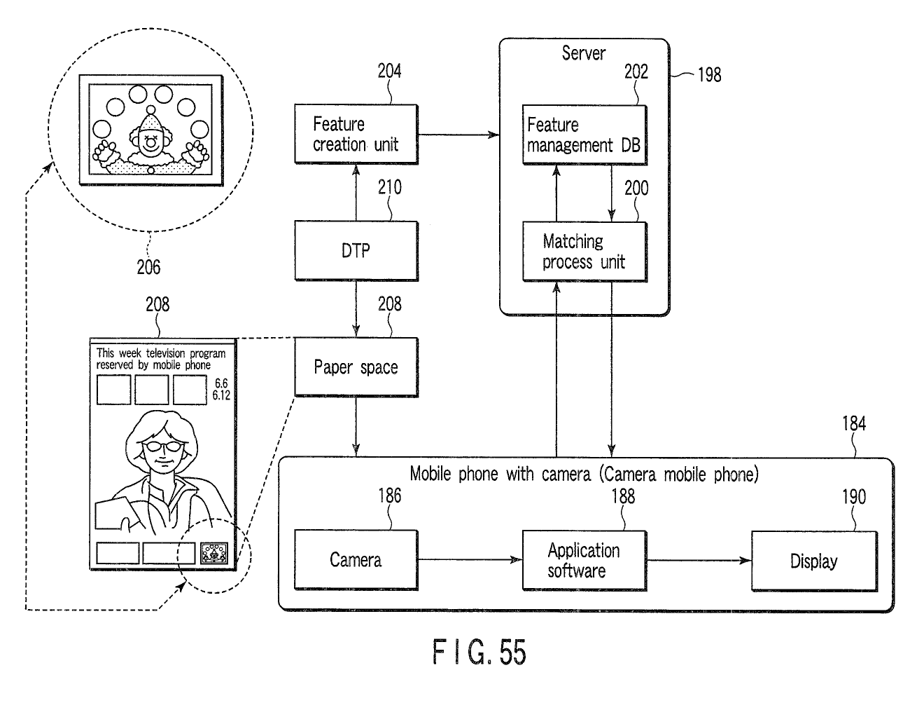

As shown in FIG. 55, the retrieval system of the eleventh application includes a mobile phone 184 with a camera 186 and a retrieval unit. The mobile phone 184 with the camera 186 includes the camera 186 for inputting an image, and a display 190 for outputting the image of the retrieval result. In accordance with the image input from the camera 186, the retrieval unit retrieves an image from a database by using features hierarchically managed. The retrieval unit is realized by application software 188 of the mobile phone 184 with the camera 186 and a matching process unit 200 configured in a server 198 communicable with the mobile phone 184 with the camera 186.

The server 198 further includes a feature management database (DB) 202 that contains a multiple items of features registered and that performs the hierarchical management thereof. Features to be registered into the feature management DB 202 is created by a feature creation unit 204 from an object image 206 arranged on a paper space 208 by using a desktop publishing (DTP) 210.

That is, in the retrieval system of the present application, the object image 206 is preliminarily printed by the DTP 210 on the paper space 208, and the features of the object image 206 are created by the feature creation unit 204. Then, the created features are preliminarily registered into the feature management DB 202 of the server 198. When a large number of object images 206 to be registered exist, the above-described creation and registration of features are repeatedly performed.

When a user desiring retrieval acquires the object image 206 from the paper face 208 by using the camera 186 of the mobile phone 184, the application software 188 performs feature extraction of an image from the input image. The application software 188 sends the extracted features to the matching process unit 200 of the server 198. Then, the matching process unit 200 performs matching with the features registered in the feature management DB 202. If a matching result is obtained, then the matching process unit 200 sends information of the matching result to the application software 188 of the mobile phone 184 with the camera 186. The application software 188 displays the result information on the display 190.

As described above, in the eleventh application, a plurality of features are extracted from the input image, and a feature set consisting of the features is comparatively matched (subjected to the matching process) with the feature set in units of the preliminarily registered object. Thereby, identification of the identical object is carried out.

The feature point in the image in this case refers to that having a difference greater than a predetermined level from an other pixel, for example, contrast in brightness, color, distribution of peripheral pixels, differentiation component value, and inter-feature point arrangement. In the eleventh application, the features are extracted and are then registered in units of the object. Then, in the event of actual identification, features are extracted by searching the interior of an input image and are compared to the preliminarily registered data.

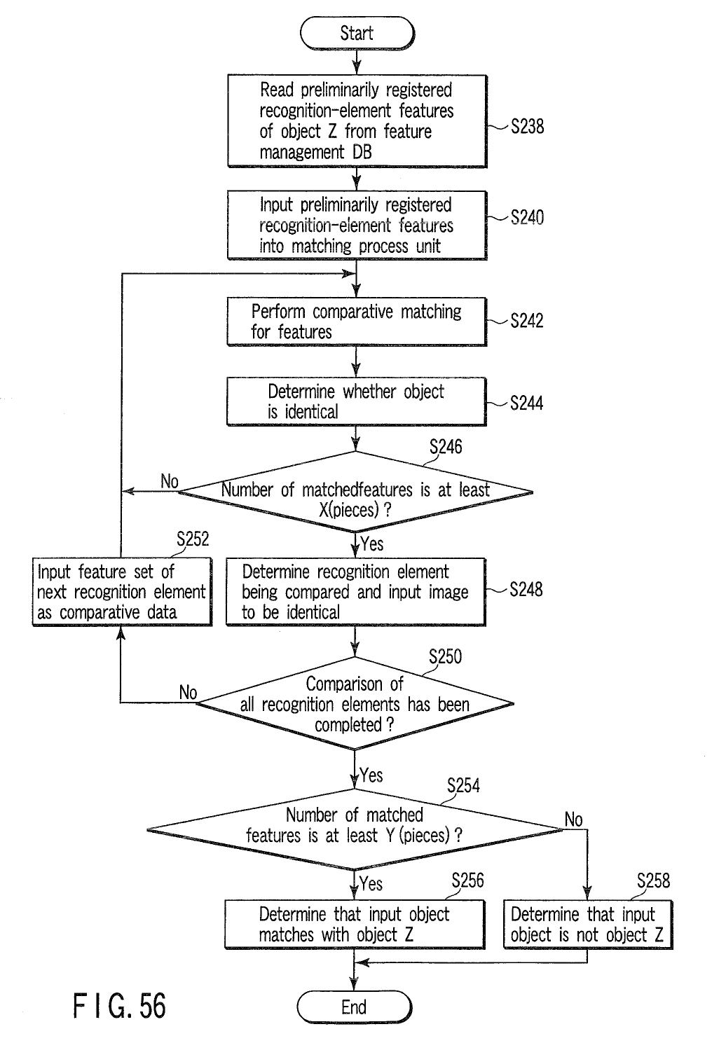

Referring to FIG. 56, the following describes the flow of operation control of an identification process in the matching process unit 200 according to the eleventh application. To begin with, preliminarily registered features of recognition elements of an object Z (object image 206, for example) is read from the feature management DB 202 containing the feature point set (step S238). Subsequently, the features are input to the matching process unit 200 that performs comparison of the features (step S240). Then, in the matching process unit 200, comparative matching between the features and the input features of the object is carried out (step S242). Thereafter, it is determined whether the object Z is identical to the input object (step S244). Thereafter, it is determined whether the number of matching features is greater than or equal to a predetermined value (X (pieces), in the present example) (step S246). If step S246 is branched to “NO”, then the process returns to step S242. Alternately, if step S246 is branched to “YES”, then it is determined that the recognition element of the object Z currently in comparison is identical to the input object (step S248).

Then, it is determined whether the comparison with all the recognition elements is finished (step S250). If step S250 is branched to “NO”, the features in the feature set of the next recognition element is input to the matching process unit 200 as comparison data (step S252), and the process returns to step S242

If step S250 is branched to “YES”, it is determined whether the number of the matching features is greater than or equal to a predetermined value (Y (pieces), in the present example) (step S254). If step S254 is branched to “YES”, then a determination is made that the input object is identical to the object Z, and is displayed on the display 190 to be notified to the user (step S256). Alternately, if step S254 is branched “NO”, then a determination is made that the input object and the object Z are not identical to one another (step S258).

In the event of actual identification, when a numeric value representing the similarity (degree) (difference between respective components of features) exceeds a preset threshold value, the feature is determined to be a similar feature. Further, an object having a plurality of matched features is determined to be identical to the object of the input image. More specifically, features in an input image and a preliminarily registered feature set are compared with one another as described herebelow.

First, the interior of an object is split into a plurality of elements, and the elements are registered. Thereby, in the event of comparative matching between objects, a determination logic is applied for recognition to determine such that the object is not recognized unless a plurality of elements (three elements, for example) are recognized.

Second, suppose that similar objects are shown in an image for object recognition, as in a case, where, for example, an S company uses an object OBJ1 (features: A, B, and C) as its logo, and an M company uses an object OBJ2 (features: E, F, and G) as its logo. In addition, the S company and the M company are assumed to be companies competitive with one another. In this case, every effort should be made to prevent confusion between the logos of the two companies. Taking these circumstances into account, according to the eleventh application, in the event that the features A and E are detected at the same time from the same screen, neither of the objects is recognized. That is, the recognition determination is made strict.

Third, conventionally, whatever the number of features is recognized, textual expression for informing the user of the recognition result is the same. As such, in the event that, for example, only some of features have been recognized, and more specifically, in the event that the identity level between the input image and the comparative image includes uncertainty, the actual state cannot be reported to the user. However, according to the eleventh application, when the number of recognition elements is small, the result displaying method (expression method) is altered to provide an expression inclusive of uncertainty such as described above.

With the respective technical measures described above, the following respective effects can be obtained.

First, the probability of causing erroneous recognition due to the identity of only part of the object can be reduced.

Second, a determination reference to be applied particularly when erroneous recognition is desired to be prevented can be specified to be strict.

Third, even when accuracy in the identity determination of the object is lower than a predetermined value, attention is directed to the user, and then the identity determination result can be reported to the user.

In the cases of the object OBJ1 (features: A, B, and C) and the object OBJ2 (features: E, F, and G), in which the features in objects are separately registered, recognition is carried out in accordance with the determination logic described herebelow.

First, unless “A and B and C” is satisfied, recognition of the object OBJ1 is not determined to be successful.

More specifically, in the event of the recognition of the object OBJ1, which consists of the recognition elements or features A, B, and C, when only one or two of A, B, and C are recognized, it is not determined that the recognition of the object OBJ1 is successful.

By way of a modified example of the above, features A, B, and C, respectively, are weighted by allocating weights as evaluation scores. For example, the features are weighted as 1.0, 0.5, and 0.3, respectively. In this case, in the event that recognition is carried out when the total evaluation score exceeds 1.5, when the features A and B are detected as recognition elements, since the total evaluation score is 1.5, the object OBJ1 is recognized.

When the features B and C are detected, the object OBJ1 is not recognized.

The evaluation scores of the recognition elements are manageable together with the features of the recognition elements.

Further, as logical expressions, the priority of the respective element can be altered, whereby not only “A and B and C,” but also a combination, such as “A and (B or C)” or “A or (B and C)”, is possible. In any of these examples, the feature A is always essential to achieve successful recognition.

The above-described examples of the evaluation scores and logical expressions can be used by being combined. More specifically, the priorities of the respective logical expressions and weights of the respective elements can be used by being combined.

Second, when “E and A” are extracted, neither the object OBJ1 nor the object OBJ2 is recognized.

For example, reference is again made to the case where the S company using the object OBJ1 as its logo and the M company using the object OBJ2 as its logo are in the competitive relation, and every effort should be made to prevent confusion between the two logos. In this case, when the object OBJ1 used as the logo of the S company and the object OBJ2 used as the logo of the M company are both displayed on the same screen, neither of the logos is recognized. In this case, the system provides the user with a display saying to the effect that the recognition is impossible not because the object images are not detected, but because the recognition elements are detected from both (A, B, and C) and (E, F, and G).

Thus, according to the eleventh application, logos of, for example, companies in the competitive relation are identified in the following manner. For example, only when only one of the object OBJ1 used as the logo of the S company and the object OBJ2 used as the logo of the M company is displayed on the acquired image, the logo is recognized. More specifically, either only one of (A, B, and C) or only one of (E, F, and G) is detected within one image, either the object OBJ1 or the object OBJ2 is recognized. In other words, any one of (A, B, and C) and any one of (E, F, and G) are detected within one image, neither the object OBJ1 nor the object OBJ2 is recognized.

Third, when only partial ones, such as “A and B,” are extracted, the result presentation method is altered (expression is made to include uncertainty).

For example, in recognition of the object OBJ1, when all the recognition elements of the features A, B, and C have been recognizable, the recognition result is presented to the user in a high-tone expression, such as “The object OBJ1 has been recognized”.

Alternatively, when two recognition elements, such as the features A and B, B and C, or A and C, have been recognizable, the recognition result is presented to the user in a low-tone expression reducing the conviction, such as “The object is considered to be the object OBJ1.” Still alternatively, when the number of recognizable elements has been one, the recognition result is presented to the user in an expression including uncertainty, such as “The object OBJ1 may have been recognized.”

As a modified example of the eleventh application, in the case where the weighting evaluation scores described above are employed, technical measures for the expression method, such as described above, for the presentation of the recognition result in accordance with the total evaluation score to the user can be contemplated. Of course, the technical measures for the expression method, such as described above, for the presentation of the recognition result to the user are adaptable in various cases. For example, the technical measures are also adaptable to recognition of a desired single recognition element. Further, the expression method as described above is adaptable to a case where the recognition result is presented to the user in accordance with, for example, the number of matched features in a recognition element and the level of identity between extracted features and already-registered features.

In the eleventh application, the feature creation unit 204 can be operated in the server 198. The paper space 208 refers to a display surface, but not necessarily be paper. For example, it can be any one of metal, plastic, and like materials, or can even be an image display apparatus, such as a liquid crystal monitor or plasma television. Of course, information displayed on those such as described above corresponds to information that is displayed in visible light regions for human beings. However, the information can be invisible for human beings as long as the information is inputtable into the camera 186. Further, since all those acquirable as images can be objects, the objects may be images such as X-ray images and thermographic images.

In FIG. 55, the image including the object image input from the camera 186 is transmitted from the mobile phone 184 with the camera 186 to the matching process unit 200 of the server 198. In this event, the image acquired by the camera 186 can of course be transmitted as it is in the form of image data, or can be demagnified and transmitted. Of course, features for use in matching can be extracted from the image and can be transmitted. Further, both the image and the features can of course be transmitted. Thus, any type of data can be transmitted as long as it is the data derivable from the image.

Additional advantages and modifications will readily occur to those skilled in the art. Therefore, the invention in its broader aspects is not limited to the specific details, and illustrated examples shown and described herein. Accordingly, various modifications may be made without departing from the spirit or scope of the general inventive concept as defined by the appended claims and their equivalents.

What is claimed is:

1. A feature matching method for recognizing an object in one of two-dimensional image data and three-dimensional image data, the method comprising:
detecting features in each of which a predetermined attribute in the one of the two-dimensional image data and three-dimensional image data takes a local maximum and/or minimum;
excluding features existing along edges and line contours from the detected features;
allocating the remaining features to a plane;
selecting some features from the allocated features by using local information; and
performing feature matching for the selected features being set as objects.

2. The feature matching method according to claim 1, further comprising:
creating a plurality of items of image data having different scales from the one of the one two-dimensional image data and one three-dimensional image data, and wherein
at least one of the detecting features, the excluding features, the allocating the remaining features, the selecting some features, and the performing feature matching performed with respect to the created plurality of different items of image data.

3. The feature matching method according to claim 1, wherein
the selecting some features uses a constraint due to texture-ness of the features.

4. The feature matching method according to claim 3, wherein
the selecting some features further uses a constraint due to an orientation.

5. The feature matching method according to claim 4, wherein
the selecting some features further uses a constraint due to a scale.

6. The feature matching method according to claim 1, wherein
the performing feature matching uses a RANSAC scheme.

7. The feature matching method according to claim 1, wherein
the performing feature matching uses a dBTree scheme.

8. The feature matching method according to claim 1, further comprising:
calculating an accuracy of the performed feature matching; and
outputting a plurality of recognition results in accordance with the calculated accuracy.

9. The feature matching method according to claim 1, wherein
the performing future matting performs matching of the one of the two-dimensional image data and three-dimensional image data in accordance with a condition of combination of a plurality of image data registered in a database, the condition being represented by a logical expression.

10. A product recognition system comprising:
a feature storing unit configured to record features of a plurality of products preliminarily registered;
an image input unit configured to acquire an image of a product;
an automatic recognition unit configured to extract features from the image of product acquired by the image input unit and to perform comparative matching for the extracted features with the features recorded in the feature storing unit, thereby to automatically recognize the product which is acquired its image by the image input unit; and
a settlement unit configured to perform a settlement process by using a recognition result of the automatic recognition unit.

11. The product recognition system according to claim 10, wherein
the automatic recognition unit uses the feature matching method according to claim 1.

12. The product recognition system according to claim 10, further comprising:
an specific information storing unit configured to record specific information of the plurality of products preliminarily registered, the specific information each including at least one of a weight and a size, and wherein
the automatic recognition unit uses the specific information recorded in the specific information storing unit to increase recognition accuracy of the product.
